(19) United States
(12) Patent Application Publication
(10) Pub. No.: US 2005/0060215 A1
(43) Pub. Date: Mar. 17, 2005

(54) Work record acquisition system, work record acquisition server, and work record acquisition program

(76) Inventors: Toshinori Mizutani, Tokyo (JP); Kazuki Suzuki, Tokyo (JP); Toshikazu Yasuoka, Tokyo (JP)

Correspondence Address: LORUSSO & LOUD, 3137 Mount Vernon Avenue, Alexandria, VA, 22305, US

(21) Appl. No.: 10/802,111

(22) Filed: Mar. 17, 2004

(30) Foreign Application Priority Data
Sep. 12, 2003 (JP) 321529

(51) Int. Cl. G06F 17/60

(52) U.S. Cl. 705/7

(57) ABSTRACT

An object of the present invention is to provide a work record acquisition system, a work record acquisition server, and a work record acquisition program that can accurately acquire a work record. In the work record acquisition system of the present invention, respective worker's terminals are connected to a work record acquisition server common to a plurality of workers through a network. A data input screen, through which at least a type of work, a work start time, and a finish of business operation can be designated under the control of the work record acquisition server, is displayed on each of the worker's terminal, and the type of work and the work start time of a new work can designated in real time making use of the data input screen. The work record acquisition server determines working hours from the start time of an immediately previous work and the start time of a new work received and stores a work record.

### CROSS-REFERENCE TO RELATED APPLICATION

This application claims, under 35 USC 119, priority of Japanese Application No.2003-321529 filed Sep. 12, 2003.

### BACKGROUND OF THE INVENTION

1. Field of the Invention

The present invention relates to a work record acquisition system, a work record acquisition server, and a work record acquisition program and intends to acquire work record information that can be reflected to a work plan and a cost prediction in, for example, a new development project.

2. Description of the Related Art

When a work plan in a new development project (for example, development of software) is made, the work record of a similar development project is utilized, and there has been proposed a system composed of a host computer and terminals for executing automatic aggregation and the like of the a work record (refer to Japanese Patent Application Laid-Open (JP-A) Nos. 5-94446 and 8-30676).

The work record is obtained by aggregating basic information, which is the information as to the hours which are consumed by each of the workers in each of a plurality of processes constituting a development project, from various points of view. In the existing system described above (in particular, JP-A No. 5-94446), each worker inputs working hours consumed by them in each process, in which the worker was engaged in a day and the like, through a terminal at an arbitrary timing such as a timing at which the service of the day is finished.

When a worker is conducted in the same process all day long, even if the worker inputs the working hours of the day through the terminal at the time the service of the day is finished, it is assumed that the input working hours are correct.

However, a plurality of types of processes are often allocated to each worker at the same time, and each worker is often engaged in a plurality of types of processes in a day. In this case, even if each worker inputs the working hours of the respective processes in which he or she was engaged in the day through the terminal, the input working hours cannot help being inaccurate because the input working hours are determined relying on memory in many cases. As a result, the work record obtained by the host computer by aggregating the work hours is also inaccurate.

### SUMMARY OF THE INVENTION

An object of the present invention is to provide a work record acquisition system, a work record acquisition server, and a work record acquisition program that can accurately acquire a work record.

In a work record acquisition system of a first invention in which respective worker's terminals are connected to a work record acquisition server common to a plurality of workers through a network, the work record acquisition server includes: a work record storage means for storing the work record of each of the workers; an input screen display control means for displaying a data input screen, on which at least a type of work, a work start time, and a finish of business operation can be designated, on each of the worker's terminals; a work record calculation/storage means for writing, when a type of work and a work start time are designated from any one of the worker's terminals, a new work record including at least the received type of work and the received work start time in the storage region of the worker relating to the worker's terminal of the work record storage means as well as writing the working hours, which are determined by the start time of an immediately previous work and the start time of the received new work, in the working hour column of the work record of the immediately previous work; and a final work record calculation/storage means for writing, when a finish of business operation is designated from any one of the worker's terminals, the working hours, which are determined by the start time of a final work and the time at which the finish of business operation is received, in the working hour column in the final work record of the worker relating to the worker's terminal of the work record storage means.

A work record acquisition server of a second invention, which is connected to respective worker's terminals through a network, includes: a work record storage means for storing the work record of each of the workers; an input screen display control means for displaying a data input screen, on which at least a type of work, a work start time, and a finish of business operation can be designated, on each of the worker's terminals; a work record calculation/storage means for writing, when a type of work and a work start time are designated from any one of the worker's terminals, a new work record including at least the received type of work and the received work start time in the storage region of the worker relating to the worker's terminal of the work record storage means as well as writing the working hours, which are determined by the start time of an immediately previous work and the start time of the received new work, in the working hour column of the work record of the immediately previous work; and a final work record calculation/storage means for writing, when a finish of business operation is designated from any one of the worker's terminals, the working hours, which are determined by the start time of a final work and the time at which the finish of business operation is received, in the working hour column in the final work record of the worker relating to the worker's terminal of the work record storage means.

A work record acquisition program of a third invention, which is mounted on a work record acquisition server connected to respective worker's terminals through a network, includes: a work record storage section for storing the work record of each of the workers; an input screen display control functional section for displaying a data input screen, on which at least a type of work, a work start time, and a finish of business operation can be designated, on each of the worker's terminals; a work record calculation/storage functional section for writing, when a type of work and a work start time are designated from any one of the worker's terminals, a new work record including at least the received type of work and the received work start time in the storage region of the worker relating to the worker's terminal of the work record storage section as well as writing the working hours, which are determined by the start time of an immediately previous work and the start time of the received new work, in the working hour column of the work record of the immediately previous work; and a final work record calculation/storage functional section for writing, when a finish of business operation is designated from any one of the worker's terminals, the working hours, which are determined by the start time of a final work and the time at which the finish of business operation is received, in the working hour column in the final work record of the worker relating to the worker's terminal of the work record storage section.

According to the work record acquisition system, the work record acquisition server, and the working record acquisition program of the present invention, since the working hours of respective works are determined based on the start time information of the works supplied from worker's terminals in real time, work records can be accurately acquired.

### BRIEF DESCRIPTION OF THE DRAWINGS

FIG. 1 is a block diagram showing an arrangement of a system of a first embodiment of the present invention;

FIG. 2 is an explanatory view showing an arrangement of a program of a first embodiment;

FIG. 3 is an explanatory view showing an arrangement of a personnel information master file of the first embodiment;

FIG. 4 is an explanatory view showing an arrangement of a production number master file of the first embodiment;

FIG. 5 is an explanatory view showing an arrangement of a work content master file of the first embodiment;

FIG. 6 is an explanatory view showing an arrangement of a work record file of the first embodiment;

FIG. 7 is an explanatory view showing an arrangement of a fingerprint master file of the first embodiment;

FIG. 8 is a sequence diagram showing a basic flow of an operation of a day of the system of the first embodiment;

FIG. 9 is an explanatory view showing a log-in screen of the first embodiment;

FIG. 10 is an explanatory view showing an ordinary employee data input screen of the first embodiment;

FIG. 11 is an explanatory view showing a management-level employee data input screen of the first embodiment;

FIG. 12 is an explanatory view showing a process menu screen of the first embodiment;

FIG. 13 is an explanatory view showing an ordinary employee data input screen after the process of the first embodiment is input;

FIG. 14 is a flowchart showing an input update operation of the work record file of the first embodiment;

FIG. 15 is an explanatory view showing a record value registration completion screen of the first embodiment;

FIG. 16 is an explanatory view showing the ordinary employee data input screen including effective information during work of the first embodiment;

FIG. 17 is an explanatory view showing a reduced window screen including information during work of the first embodiment;

FIG. 18 is a sequence diagram showing a self record value reference operation of the first embodiment;

FIG. 19 is an explanatory view showing a self record value reference screen of the first embodiment;

FIG. 20 is a sequence diagram showing a self record value edit operation of the first embodiment;

FIG. 21 is an explanatory view showing a self record value edit screen of the first embodiment;

FIG. 22 is an explanatory view showing a record value edit and input screen of the first embodiment;

FIG. 23 is an explanatory view showing a subordinate record value edit screen of the first embodiment;

FIG. 24 is an explanatory view showing a log-in screen of a second embodiment;

FIG. 25 is a flowchart showing an employee authentication processing of the second embodiment;

FIG. 26 is an explanatory view showing a management-level employee data input screen of a third embodiment;

FIG. 27 is an explanatory view showing a modified screen of the management-level employee data input screen of the third embodiment;

FIG. 28 is an explanatory view showing a process menu screen of the third embodiment;

FIG. 29 is a flowchart showing processing of the third embodiment for reflecting registered project information of each employee to system project information;

FIG. 30 is an explanatory view showing a project menu screen of the third embodiment;

FIG. 31 is an explanatory view showing a personal button menu screen of the third embodiment; and

FIG. 32 is an explanatory view of a personal work content file of other embodiment.

### DESCRIPTION OF THE PREFERRED EMBODIMENTS

(A) First Embodiment

A first embodiment of a work record acquisition system, a work record acquisition server, and a work record acquisition program according to the present invention will be explained in detail with reference to the drawings.

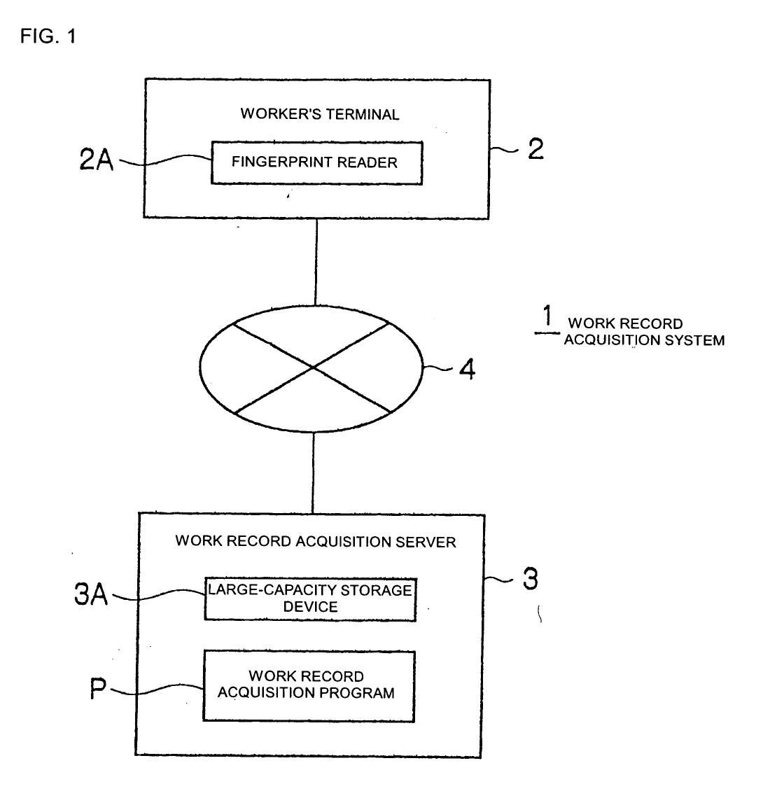

FIG. 1 is a block diagram showing the overall arrangement of the work record acquisition system of the first embodiment.

The work record acquisition system 1 of the first embodiment is composed of worker's terminals 2 of respective workers connected to a work record acquisition server 3 through a network (for example, an inter-office network) 4.

Each worker's terminal 2 is composed of an ordinary information processing device such as a personal computer, and the like. Accordingly, illustration and explanation of the hardware arrangement of the worker's terminal 2 are omitted Note that, in first embodiment, the worker's terminal 2 has a fingerprint reader 2A as a peripheral device.

The work record acquisition server 3 is composed of an ordinary information processing device such as a personal computer provided with a large-capacity external or internal storage device 3A or a server having a processing capacity larger than that of the personal computer and the like, and the work record acquisition server 3 is constructed by installing the work record acquisition program P on the information processing device. The work record acquisition server 3 is arranged as a web server by being installed with, for example, the work record acquisition program P.

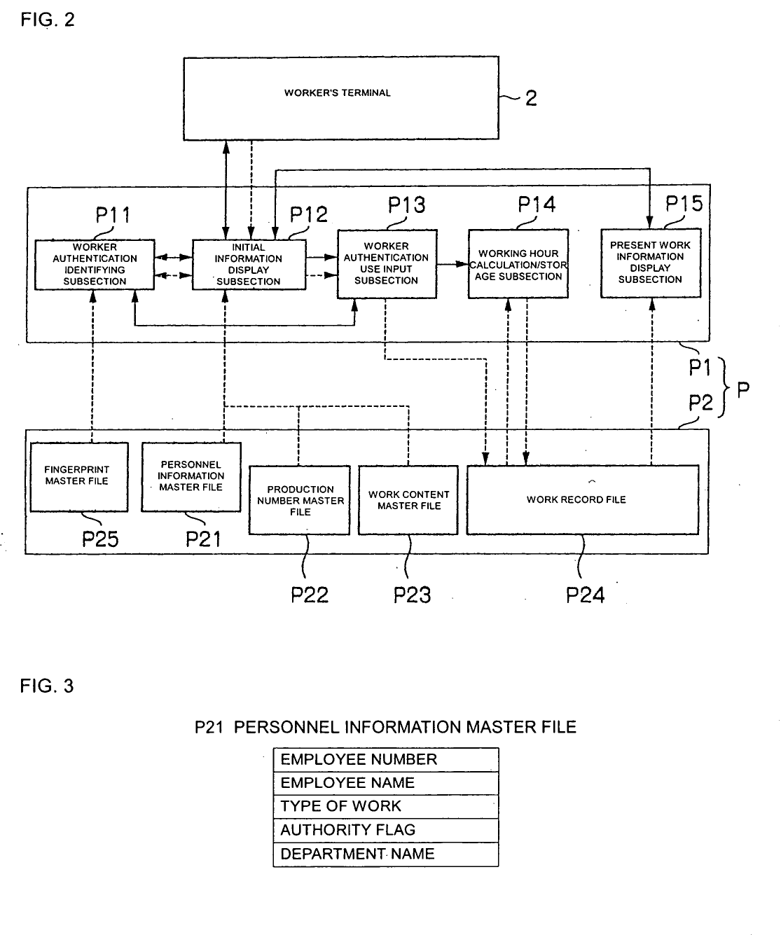

As shown in FIG. 2, the work record acquisition program P is broadly composed of a function executing section (routines for processing respective functions) P1 and a data storage section P2. The function executing section P1 is stored in, for example, a memory in the main body of the work record acquisition server 3 and/or the large-capacity storage device 3A thereof, and the data storage section P2 is stored in, for example, the large-capacity storage device 3A.

The function executing section P1 includes processing routines such as a worker authentication identifying subsection P11, an initial information display subsection P12, a worker authentication use input subsection P13, a working hour calculation/storage subsection P14, a present work information display subsection P15, and the like. When these processing routines are assembled in the work record acquisition server 3, a means for executing the routines is formed. The functions of these processing routines will become apparent in the following explanation of operations.

The data storage section P2 has a personnel information master file P21, a production number master file P22, a work content master file P23, a work record file P24, a fingerprint master file P25, and the like.

As shown in FIG. 3, the personnel information master file P21 is composed of the data of employee numbers, employee names, types of work, authority flags, and department names of respective employees (workers). Any one of three levels, for example, a level for ordinary employees, a level for management-level employees and a level for manager employees of this system is set to the authority flag in correspondence to a level (authority) that can correct the work record file P24. The relationship between the ordinary employees and the management-level employees of a particular department can be grasped by the authority flag and the information of the name of the department. A plurality of types of works may be input, as explained later.

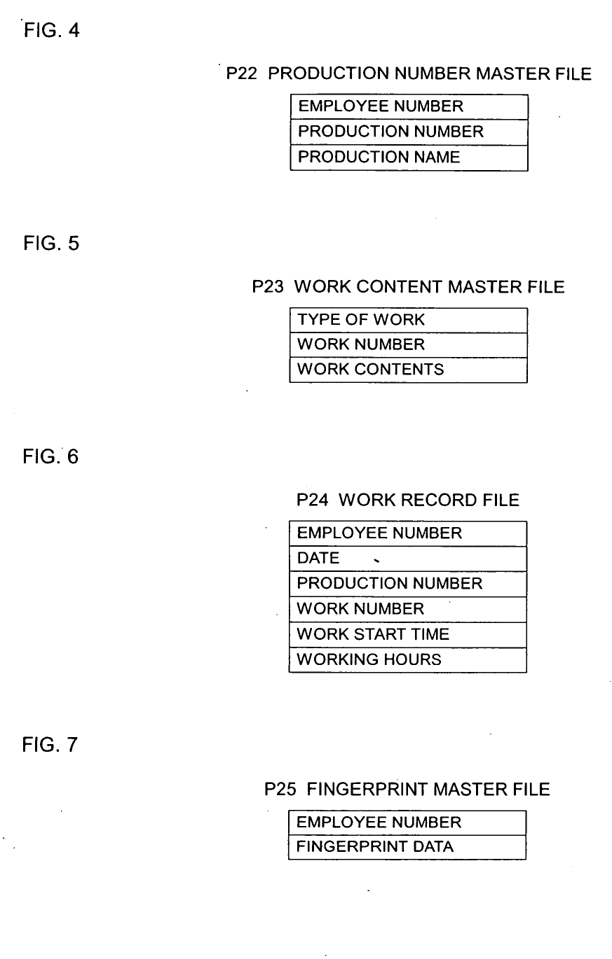

As shown in FIG. 4, the production number master file P22 is composed of the data of the employee numbers, the production numbers, and the production names of the respective employees. A plurality of production number and a plurality of production names may be described for one employee. A group of a production number and a production name shows, for example, a type of a development project, a type of a product, and the like.

As shown in FIG. 5, the work content master file P23 is composed of the data of the type of work, the work number, and the work contents of each work. A plurality of work numbers and a plurality of work contents are described for one type of work. A group of a work number and work contents shows a specific type of work such as a “meeting”, “creation of an estimate”, and the like. The works, which are executed by workers, are classified into a various types of works such as a work for developing hardware, a work for developing software, a work for partly developing software, and the like from the view point that the works executed by the workers are entirely or partly different depending on the contents thereof.

As shown in FIG. 6, the work record file P24 is composed of the data of the employee numbers, the dates (working dates), the production numbers, the work numbers, the work start times, and the working hours of the respective employees. A plurality of groups of the data of the production numbers, the work numbers, the work start times, and the working hours may be described in a day's data. Further, data having different dates is included.

As shown in FIG. 7, the fingerprint master file P25 is composed of the employee numbers and the fingerprint data of the respective employees.

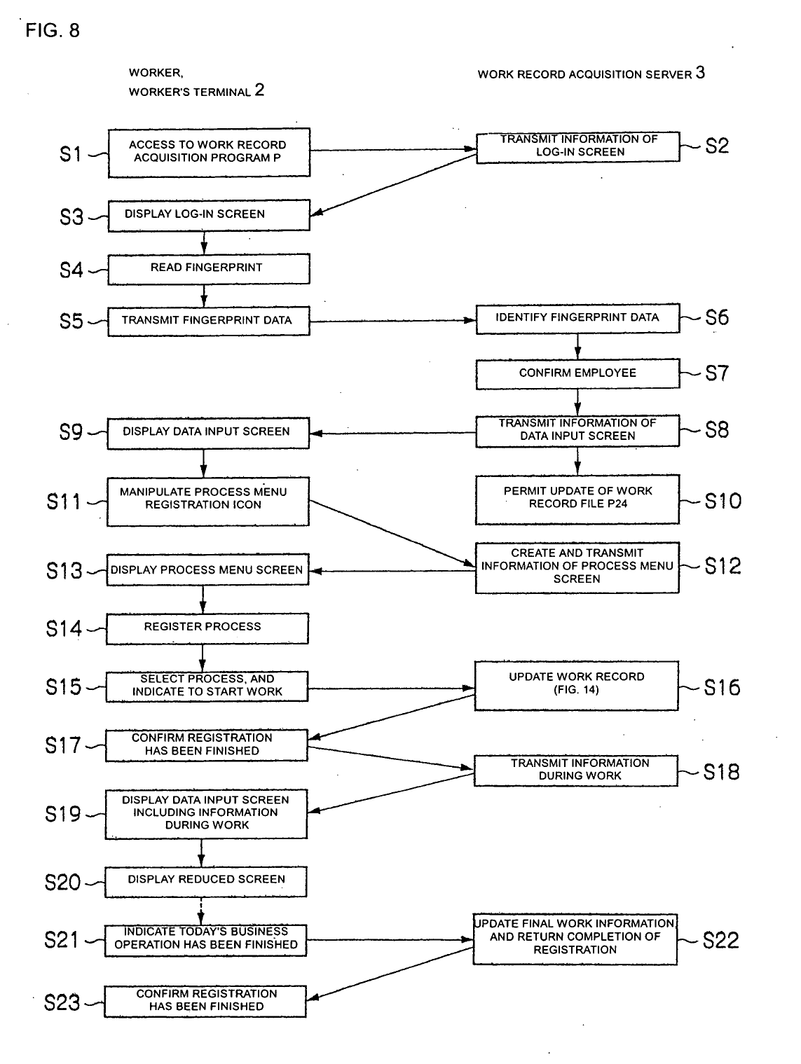

Next, the operation of the work record acquisition system 1 will be explained. FIG. 8 is a sequence diagram showing the manipulation of a worker executed to the worker's terminal 2 in a day and the processing executed by the worker's terminal 2 and the work record acquisition server 3.

The worker attends his or her office and accesses the work record acquisition program P of the work record acquisition server 3 using, for example, a web browser in the worker's terminal 2 before the worker starts an initial work (S1).

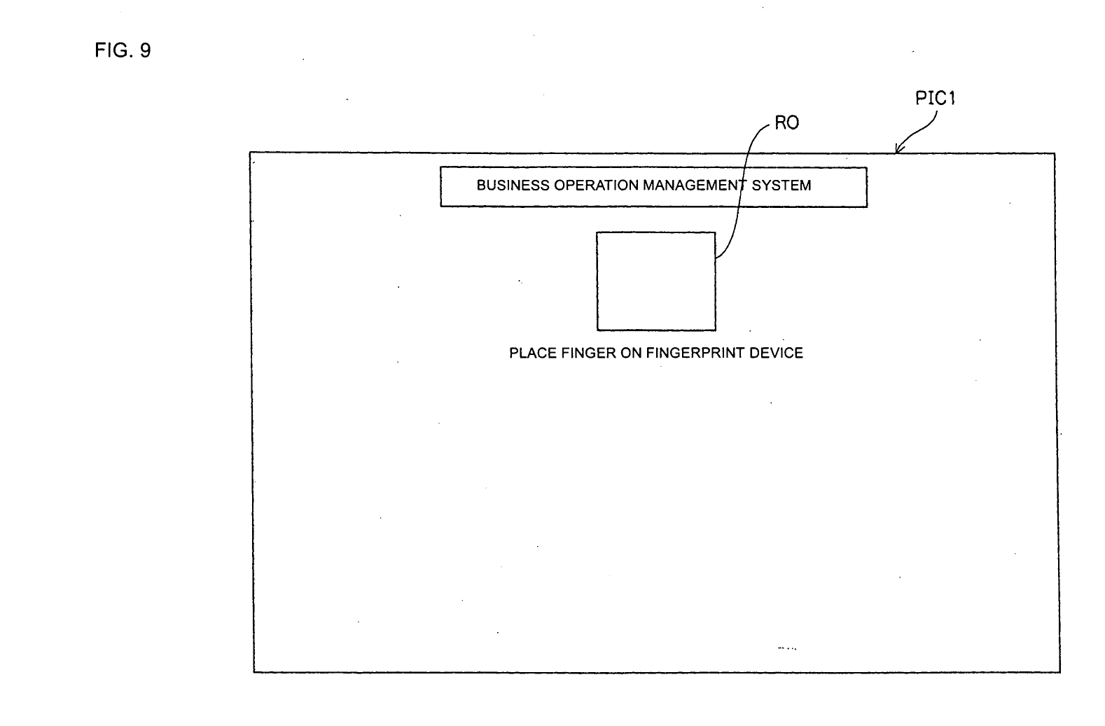

At the time, the work record acquisition server 3 transmits the information of a log-in screen PIC1, which requires to input a fingerprint as shown in FIG. 9, to the worker's terminal 2 by the function of the initial information display subsection P12 of the work record acquisition program P and causes the worker's terminal 2 to display the log-in screen PIC1 (S2, S3).

In response to the above operation, the worker causes the fingerprint reader 2A to read a fingerprint (S4). With the above operation, the worker's terminal 2 additionally displays the fingerprint (fingerprint image) having been read in a fingerprint display region RO of the log-in screen PIC1 being displayed as well as transmits the fingerprint data to the work record acquisition server 3 (S5).

The work record acquisition server 3 identifies the fingerprint data supplied from the worker's terminal 2 with the fingerprint data in the fingerprint master file P25 by the function of the worker authentication identifying subsection P11 of the work record acquisition program P (S6).

Note that although the fingerprint data of one finger is registered in the fingerprint master file P25 and used for identification in the above description, the fingerprint data of a plurality of fingers may be used for identification.

For example, the fingerprint data of a plurality of fingers may be registered in the fingerprint master file P25 (it is preferable that the fingerprint data of both the hands be mixed), the fingerprint of one finger may be read each time, and the matching of the fingerprint may be determined when the read fingerprint matches any one of the registered fingerprint data of the plurality of fingers. Further, for example, the fingerprint data of a plurality of fingers may be registered to the fingerprint master file P25, the fingerprints of a plurality of fingers are read each time, and an employee may be specified when the major part of the read fingerprint data is matched. Further, for example, the fingerprint data of a plurality of fingers may be registered to the fingerprint master file P25, the fingerprint of one finger may read each time, and when there is only one employee whose fingerprint is matched in first identification, the identification processing may be finished. Whereas, when there are a plurality of employees whose fingerprints are matched in the first identification, the fingerprint data of other finger may be captured from the worker's terminal 2 again for identification, and the above processing may be repeated until one employee is specified. In this case, it is preferable to set a threshold value for determining matching somewhat loosely.

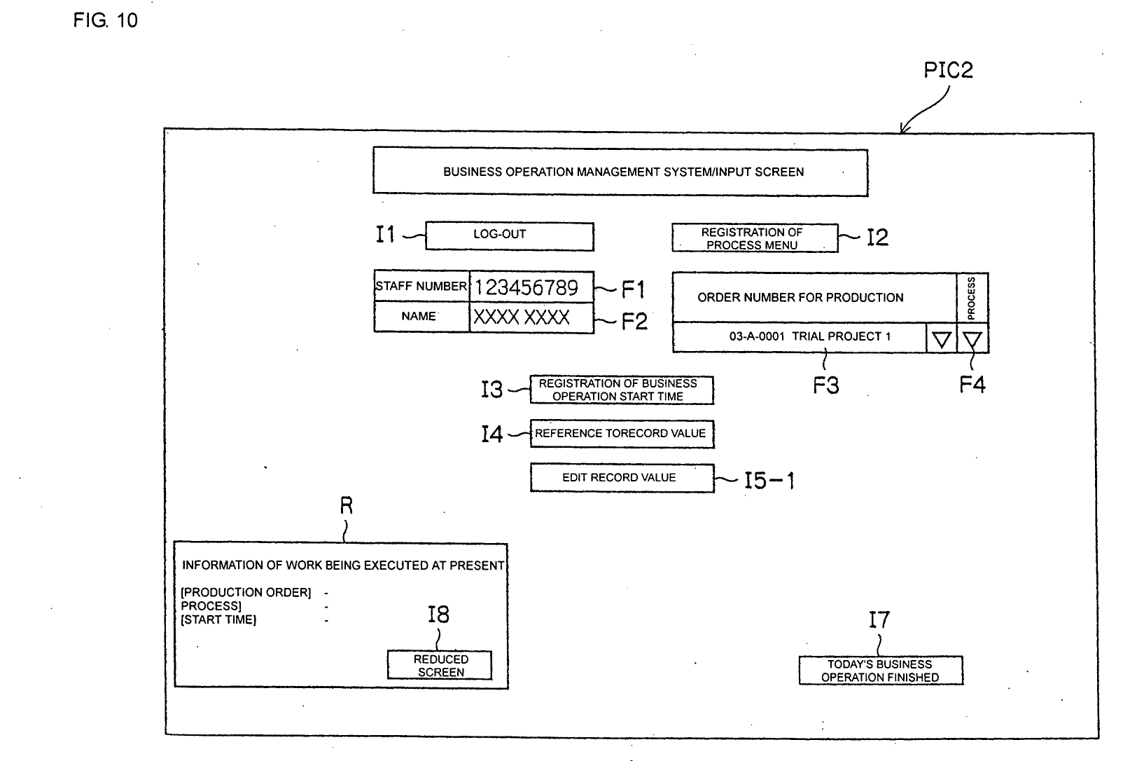

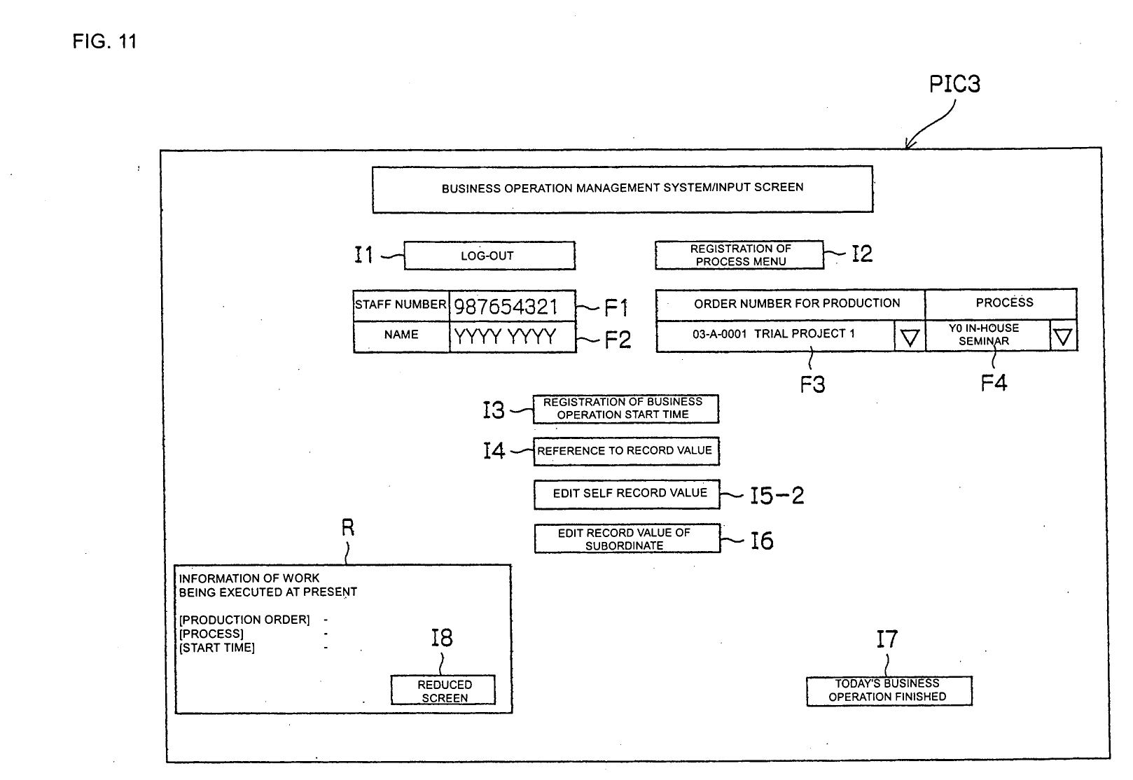

When matched fingerprint data (or a group of matched fingerprint data) is found in the work record acquisition server 3, an employee number corresponding to the fingerprint data (or the group of fingerprint data) is taken out from the fingerprint master file P25, predetermined information is taken out from the personnel information master file P21 and the production number master file P22 based on the employee number by the function of the initial information display subsection P12 of the work record acquisition program P, the information of a data input screen as shown in FIG. 10 or 11, which appropriately includes the taken-out information, is transmitted to the worker's terminal 2, and a data input screen PIC2 or PIC3 is displayed on the worker's terminal 2 (S7 to S9). Further, at this time, the employee number is supplied from the worker authenticating identification subsection P11 to the worker authentication use input subsection P13 so that the information and the like of the employee in the work record file P24 can be updated (S10).

That is, in the work record acquisition system 1 of the embodiment, log-in can be executed only by the identification of fingerprint. Since the work record of each worker acquired by the work record acquisition system 1 of the embodiment can be used to the efficiency rating and the like of each worker, each worker must be accurately authenticated, and, for this purpose, the authentication system by means of the fingerprint identification is employed. Further, the log-in can be executed speedily by harmonizing a log-in system with a person identification system, thereby a preprocessing time before a work is started can be reduced.

Note that when a result that fingerprint data, which matches a fingerprint to be identified, is not registered in the fingerprint master file P25, an error message screen is transmitted from the work record acquisition server 3 to the worker's terminal 2 and displayed thereon, although this is not illustrated.

FIG. 10 shows the data input screen PIC2 when the authority flag in the personnel information master file P21 represents an ordinary employee, and FIG. 11 shows the data input screen PIC3 when the authority flag in the personnel information master file P21 represents a management-level employee. Although illustration is omitted, a data input screen when the authority flag in the personnel information master file P21 represents a manager employee of the system is approximately the same as that of the data input screen PIC3 of the management-level employee.

A display field F1 named a “staff number” and a display field F2 named a “name” in the data input screen PIC2 or PIC3 shown in FIG. 10 or 11 show an employee number and an employee name, respectively. The employee number corresponds to the fingerprint data, which matches read fingerprint data, of the fingerprint master file P25, and the employee name is acquired from the personnel information master file P21 using the employee number as a key.

To cope with the case that the contents, which are displayed in the display fields F1 or F2 of the “staff number” and the “name” in the data input screen PIC2 or PIC3 shown in FIG. 10 or 11, are incorrect, for example, a button icon for returning to the processing described above may be included in the data input screen PIC2 or PIC3 shown in FIG. 10 or 11. The button icon is automatically erased from a display when, for example, an icon other than it is manipulated. Further, when the work record acquisition server 3 is notified to return to the above processing because the displayed contents of the “staff number” and the “name” are incorrect, the work record acquisition server 3 makes a reference for determining matching of registered fingerprint data more strict.

An input display field F3, which is named an “order number for production” in the data input screen PIC2 or PIC3 shown in FIG. 10 or 11, displays a group of a production number and a production name (although the term “production” is used, the term also includes a product other than a physical existence such as software and the like), and the group of the production number and the production name can be changed by displaying a menu through a menu display start icon at the right end of the input display field F3. The production number and the production name are acquired from the production number master file P22 using the employee number as a key.

An input display field F4 named a “process” displays a group of the work number and the work contents, and the group of the work number and the work contents can be changed by displaying a menu through a menu display start icon at the right end of the input display field F4. In the data input screens PIC2 and PIC3 displayed immediately after the log-in, the input display field F4 remains blank (that is, no process is registered). Note that FIG. 10 shows a display state before the process is registered, and FIG. 11 shows a display state after the process is registered.

A “log-out” icon I1 indicates the worker's terminal 2 to log-out from the work record acquisition server 3 (in other words, from the work record acquisition program P).

A “process menu registration” icon I2 starts processing for registering one group or a plurality of groups of work numbers and work contents to the input display field F4 (which will be described later).

A “business operation start time registration” icon I3 starts processing for registering the start time of the work of the production name prescribed in the input display fields F3 and F4 (which will be described later). In the first embodiment, the “registration of business operation start time” icon I3 indicates the finish time of a work just before the above work from a different point of view.

A “reference to record value” icon I4 starts processing for referring to the contents stored in the work record file P24 (which will be described later).

A “edit record value” icon I5-1 in the data input screen PIC2 shown in FIG. 10 and a “edit self record value” icon I5-2 in the data input screen PIC3 shown in FIG. 11 start processing for editing the work record of the employee in the work record file P24 (which will be described later).

A “edit record value of subordinate” icon I6 in the data input screen PIC3 shown in FIG. 11 starts processing for editing the work record of a subordinate of the employee (which will be described later). A data input screen (not shown) of the manager employee of the system is provided with a “managed employee record value edit” icon in place of the “edit record value of subordinate” icon I6.

In the data input screen PIC2 or PIC3 shown in FIG. 10 or 11, a “today's business operation finished” icon I7 starts processing for finishing a final work in the day.

In the data input screen PIC2 or PIC3 shown in FIG. 10 or 11, a display region (hereinafter, referred to as a “information during work display region) R is a region for displaying the information during a work being executed at present, the information being composed of a production order (which is prescribed by the production number and/or the production name), the process (which is prescribed by the work number and/or the work contents), the work start time, and the like. The background color (for example, red) in the information during work display region R is set to a color different from the background color (for example, gray) of the data input screens PIC2 and PIC3 in their entirety.

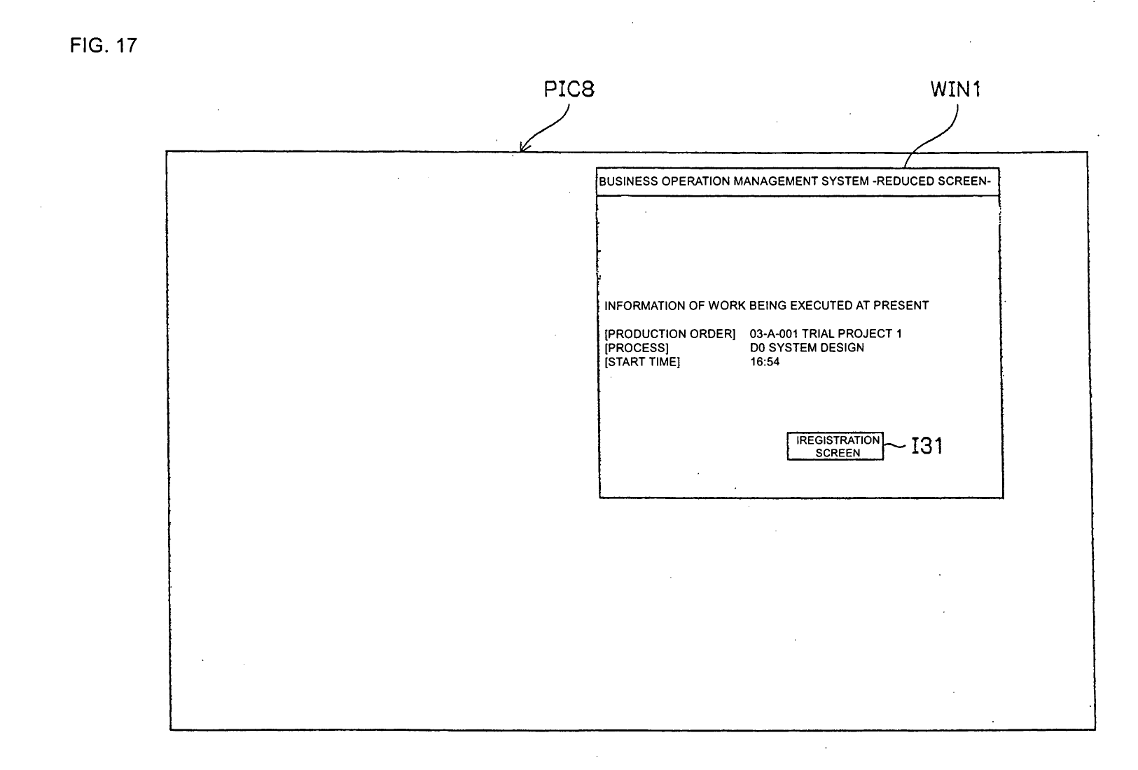

A “reduced screen” icon I8 in the information during work display region R starts processing for displaying a reduced window screen which includes the information during the work being executed at present and is smaller than the data input screens PIC2 and PIC3 in place of them (refer to WIN1 in FIG. 17).

Since the process is not displayed on the data input screens PIC2 and PIC3 displayed immediately after the log-in, a worker manipulates the “registration of process menu” icon I2 to register the process (S11).

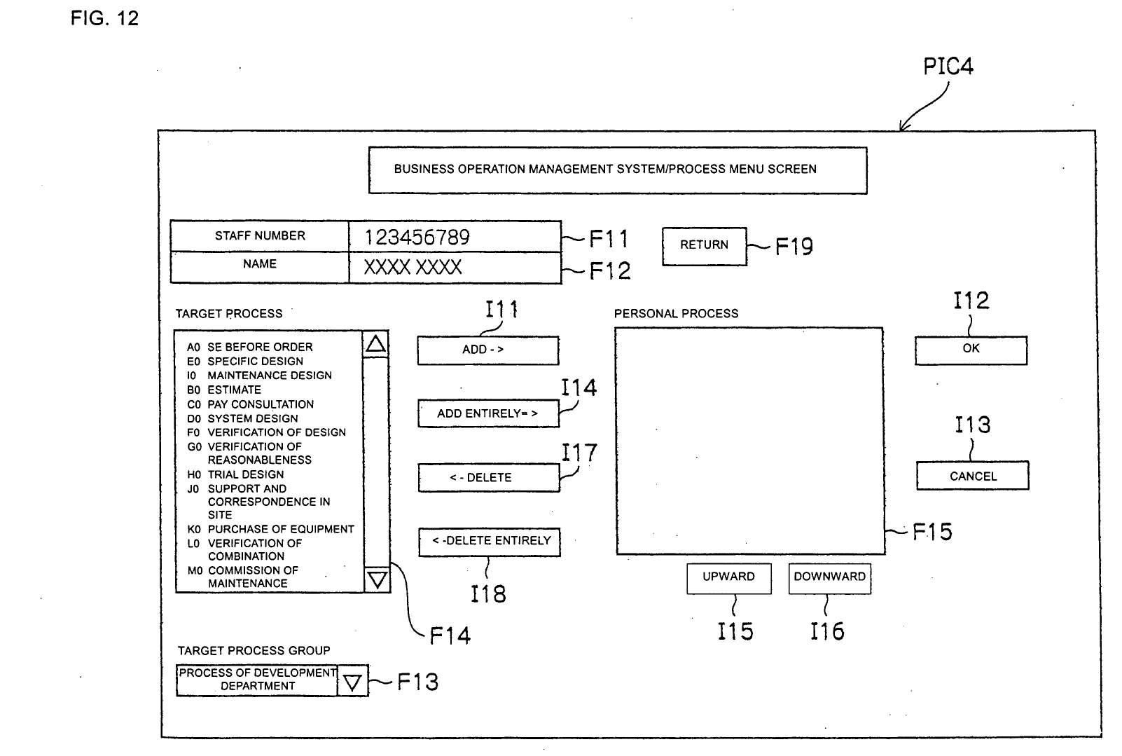

The work record acquisition server 3, which is notified from the worker's terminal 2 that the “registration of process menu” icon 12 was manipulated, takes out all the types of works of the employee from the personnel information master file P21 based on the employee number of the employee by the function of the initial information display subsection P12 of the work record acquisition program P, further takes out all the work numbers and work names of the types of works from the work content master file P23, transmits the information of a process menu screen PIC4 as shown in FIG. 12, which appropriately includes the thus taken-out information, to the worker's terminal 2, and displays the process menu screen PIC4 on the worker's terminal (S12, S13).

Thereafter, the process (the work number and the work contents), which the employee intends to executes, is registered by the cooperative operations of the work record acquisition server 3 and the worker's terminal 2 executed in response to the manipulation of the process menu screen PIC4 executed by the worker (S14).

A process registering operation executed by the cooperative operation of the work record acquisition server 3 and the worker's terminal 2 will be explained below together with the arrangement of the process menu screen PIC4.

The process menu screen PIC4 shown in FIG. 12 includes display fields F11 and 12 of the staff number (employee number) and the name (employee name). Further, the process menu screen PIC4 includes an input display field F13 of a process group name (type of work) and a display field 14F of a list of the processes (work contents) belonging to the process group. The type of work displayed in the input display field F13 can be changed to other type of work, and when it is changed to the other type of work, the list of the processes (work contents) displayed in the display field 14F is also changed according to the change of the type of work. Further, the process menu screen PIC4 includes an input display field F15 for displaying a process that is intended to be registered to an individual (employee).

The respective processes in the process list display field 14F can be alternatively marked by clicking a mouse unit of the worker's terminal 2 (note that a plurality of marks may be admitted) and moved to the input display field F15 by sequentially manipulating an “add” icon I11 and an “OK” icon I12. The movement is made invalid even after the “add” icon I11 is manipulated by manipulating a “cancel” icon I13.

All the processes in the process list display field F14 are moved to the input display field F15 at a time by sequentially manipulating an “add all” icon I14 and the “OK” icon I12. The movement executed at a time is made invalid even after the “add all” icon I14 is manipulated by manipulating the “cancel” icon I13.

The respective processes in the input display field F15 can be alternatively marked by clicking the mouse unit of the worker's terminal 2 (note that a plurality of marks may be admitted) and moved to the process list display field 14F by sequentially manipulating a “cancel” icon I17 and the “OK” icon I12. The movement is made invalid even after the “cancel” icon I17 is manipulated by manipulating the “cancel” icon I13.

All the processes in the input display field F15 are moved to the process list display field 14F at a time by sequentially manipulating an “delete all” icon I18 and the “OK” icon I12. The movement is made invalid even after the “delete all” icon I18 is manipulated by manipulating the “cancel” icon I13.

The process in the input display field F15 can be shifted to a position just above or just below the present position thereof by manipulating an “up” icon I15 or a “down” icon I16.

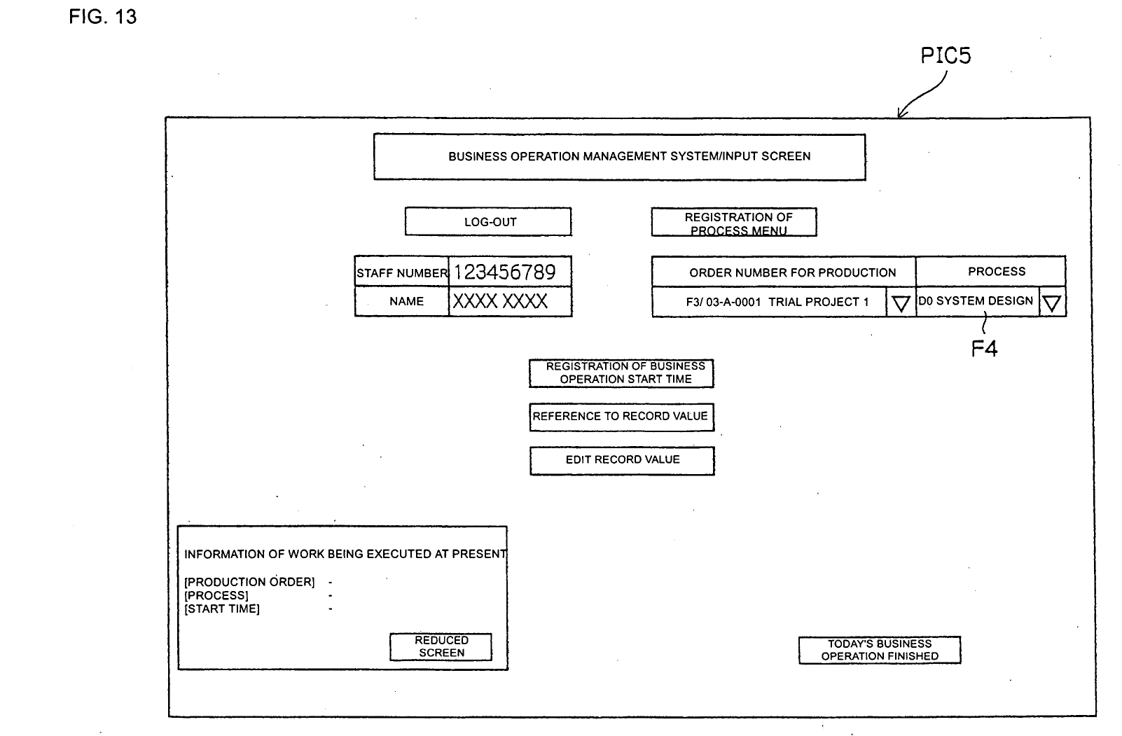

The process menu screen PIC4 is returned to a data input screen PIC5 by manipulating a “return” icon I19, and the process at the uppermost position of the input display field F15 of the process menu screen PIC4 is displayed in the input display field F4 of the data input screen. FIG. 13 shows the data input screen PIC5 returned from the process menu screen PIC4.

Before the worker starts a new work, he or she can register a process (work number and work name) making use of the process menu screen PIC4 each time the new work is started. Further, before the worker starts an initial work of the day, he or she can register the processes (work numbers and work names) which will be executed in the day including the initial work at a time making use of the process menu screen PIC4.

When a process, which prescribes a work to be executed hereinafter, is displayed in the input display field F4 of the data input screens (such as PIC5 and the like), the worker manipulates the “registration of business operation start time” icon I3 (S15).

On receiving the above manipulation information from the worker's terminal 2, the work record acquisition server 3 updates the work record of the specific employee of the work record file P24 by the function of the working hour calculation/storage subsection P14 of the work record acquisition program P (S16).

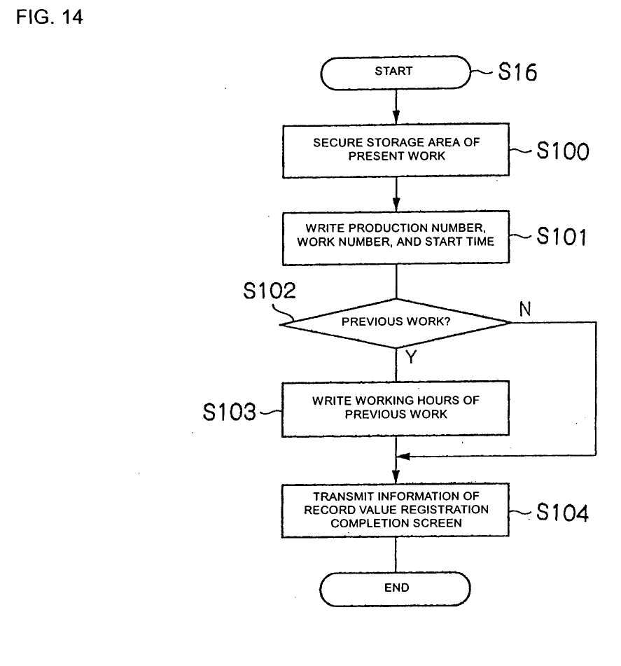

FIG. 14 is a flowchart showing processing when the work record is updated. When the processing shown in FIG. 14 is started in the working hour calculation/storage subsection P14, a CPU of the work record acquisition server 3 first secures an area for storing the production number, the work number, the work start time, and the working hours of the new work (S100), the production number of the input display field F3 in the data input screen is written to a production number area, the work number of the input display field F4 in the data input screen is written to a work number area, and the time of an incorporated timer at the time the manipulation information of the “registration of operation start time” icon 13 is received is written to a work start time area (S101). Note that a working hour area remains blank.

Next, the CPU of the work record acquisition server 3 determines whether or not there is a work executed before the above work on the day (S102). When there is not the previous work, the flow immediately moves to step S104 which will be described later, whereas when there is the previous work, the working hours in the previous work are calculated from the start time of the previous work and the start time of the present work and the like and written to the working hour area of the previous work (S103).

The working hour calculation/storage subsection P14 has the fixed data of non-working hours such as a lunchtime and the like (note that the personnel information master file P21 may be provided with the information of the non-working hours), and when there are non-working hours between the start time of the previous work and the start time of the present work, the working hour calculation/storage subsection P14 calculates the working hours of the previous work by subtracting the non-working hours from the hours obtained from the difference between the start time of the previous work and the start time of the present work. When, for example, the start time of the previous work is AM 11:00, the start time of the present work is PM 1:30, and the lunchtime is set from noon to PM 1:00 (one hour), 1.5 hours (1.5=13.5−11−1) is calculated as the working hours of the previous work.

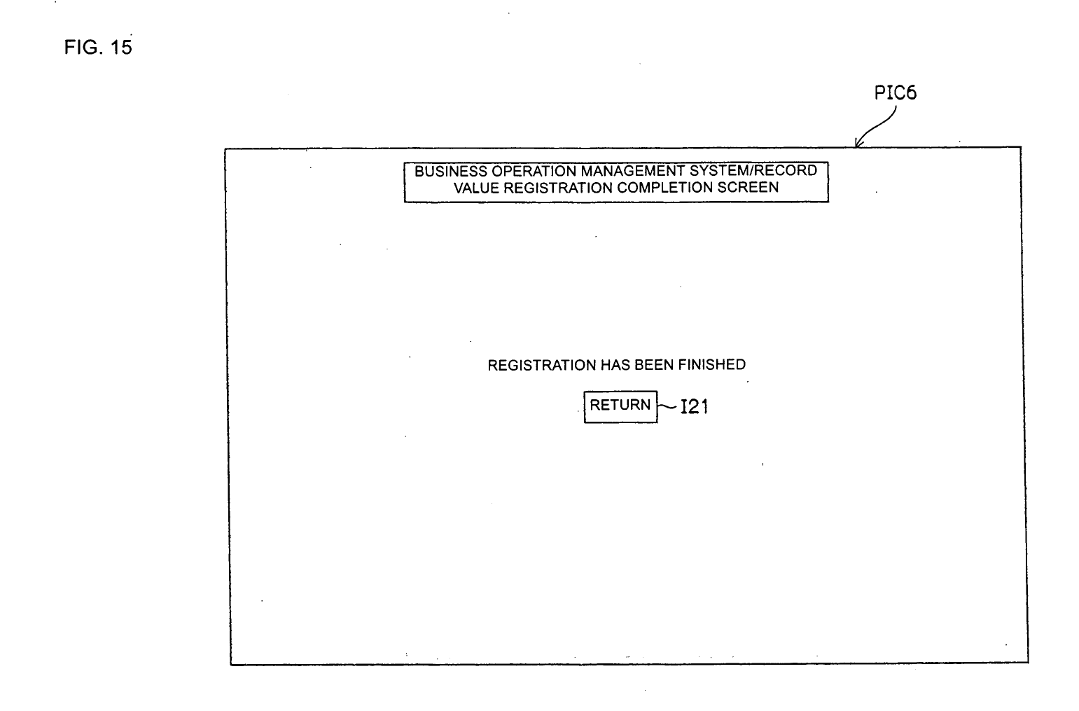

Thereafter, the work record acquisition server 3 transmits the information of a record value registration finish screen PIC6 shown in FIG. 15 to the worker's terminal 2 and displays it thereon (S104).

The record value registration finish screen PIC6 includes a message showing that the information of the present work has been registered as well as includes a “return” icon I21. When the “return” icon I21 is manipulated by the worker, information as to the manipulation is transmitted from the worker's terminal 2 to the work record acquisition server 3 (refer to S17 of FIG. 8).

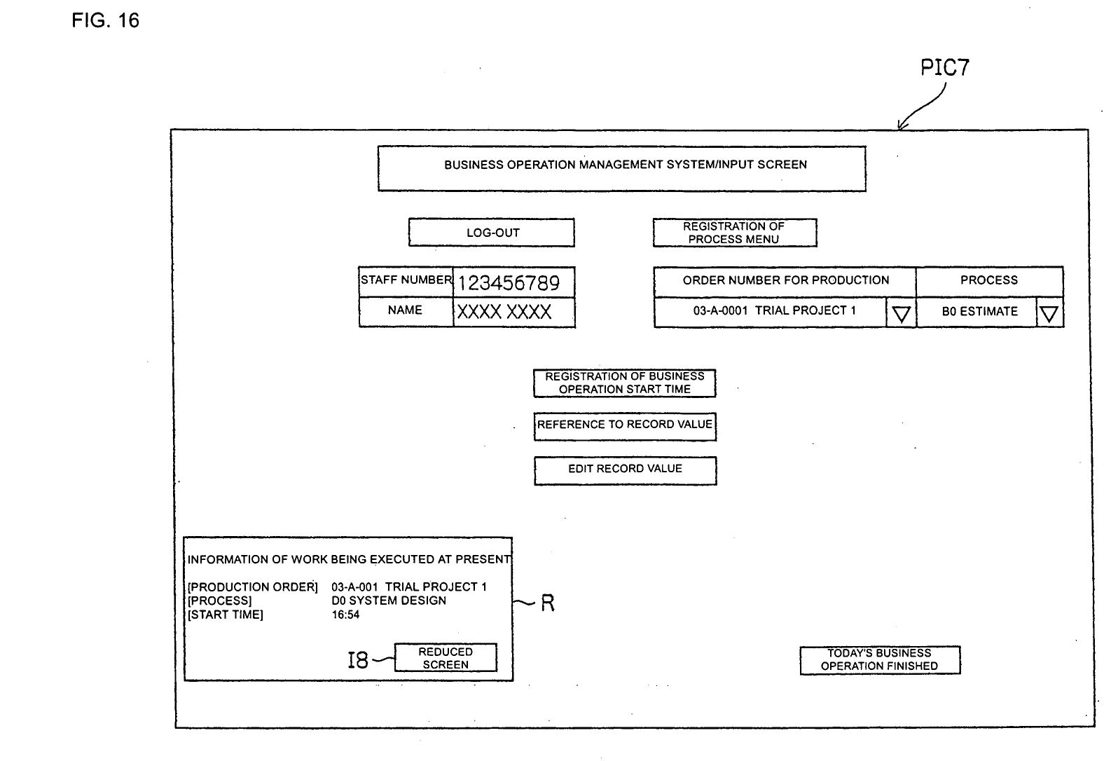

On receiving the information of the manipulation, the work record acquisition server 3 transmits information for displaying a data input screen PIC7 as shown in FIG. 16, which includes information during work effective to the information during work display region R, to the worker's terminal 2 by the function of the present work information display subsection P15 and the initial information display subsection P12 and displays it on the worker's terminal 2 (S18, S19). Note that when the information of the record value registration finish screen PIC6 is transmitted, information for displaying the information during work may be transmitted together with it to resume the data input screen PIC7.

The worker can execute a registered work in this state. When the work is a work using, for example, the worker's terminal 2, the worker manipulates the “reduced screen” icon I8 in the information during work display region R. At the time, the worker's terminal 2 displays the reduced window screen WIN1 as shown in FIG. 17, which includes the information during work, on a part of a display screen PIC8 just before the data input screens (PIC7 and the like) are displayed based on a processing program corresponding to the “reduced screen” icon I8 (S20).

The reduced window screen WIN1 includes a “registration screen” icon I31, and the worker can easily return a display to the data input screens (PIC7 and the like) by manipulating the “registration screen” icon I31.

Note that the OS of an ordinary personal computer and the like has an icon for minimizing a display at the upper right corner of a display screen, and thus the OS has such a function that a displayed file is minimized by manipulating the minimizing icon and an icon having a file name is displayed in a row of a list of files being logged in. In comparison with the minimizing icon arranged as described above, the “reduced screen” icon I8 indicates to display the information during work at all times as well as displays the reduced window screen WIN1 including the “registration screen” icon I31 located at an easily viewable position. Thus, the display can be securely returned to the data input screens (PIC7 and the like) before a next work is started, thereby usability can be enhanced.

Although omitted in FIG. 8, each time the worker starts a new work, he or she displays a data input screen, designates a process (work number and work name), manipulates the “registration of business operation start time” icon I3, and causes the work record acquisition system 1 to execute an operation similar to that described above. When processes are designated in second and subsequent works, they may be registered making use of the process menu screen PIC4 shown in FIG. 12 and described above. Otherwise, the processes may be registered when the processes of the works up to that time were registered using the process menu screen PIC4 and may be selectively designated by a process selection function in the input display field F4.

When the business operation of the day is finished, the worker manipulates a “today's business operation finished” icon I7 in the data input screen. At the time, the worker's terminal 2 transmits the information as to the manipulation of the icon to the work record acquisition server 3 (refer to S21 of FIG. 8).

On receiving the manipulation information, the work record acquisition server 3 calculates the hours from the start time of a final work to the time at which the manipulation information was received as the working hours of the final work whose working hour area remains blank by the function of the working hour calculation/storage subsection P14, writes the hours to the working hour area of the final work in the work record file, transmits the information of the record value registration finish screen PIC6 shown in FIG. 15 and described above to the worker's terminal, and displays the information thereon (S22, S23).

Thereafter, although omitted in FIG. 8, the worker displays the data input screen by manipulating a “return” icon I21 of the record value registration finish screen PIC6 shown in FIG. 15 and further manipulates the log-out icon I1, thereby the worker's terminal 2 and the work record acquisition server 3 are subjected to log-out processing.

Note that even if a screen is returned to the data input screen, the work record acquisition server 3, to which the record hours of the final work have been registered, makes the manipulation of the “registration of operation start time” icon I3 invalid according to the manipulation of the “today's business operation finished” icon I7. However, the “reference to record value” icon I4, the “edit record value” icon I5-1, and the like continuously remain valid, thereby it is possible to refer to and to edit a work record.

Although the flow of the operation in an ordinary day executed by the work record acquisition system 1 of the first embodiment has been shown above, the system 1 is provided with a work record confirmation function (reference function), an edit function, and the like in consideration of a case that the worker is away from the office, and the like.

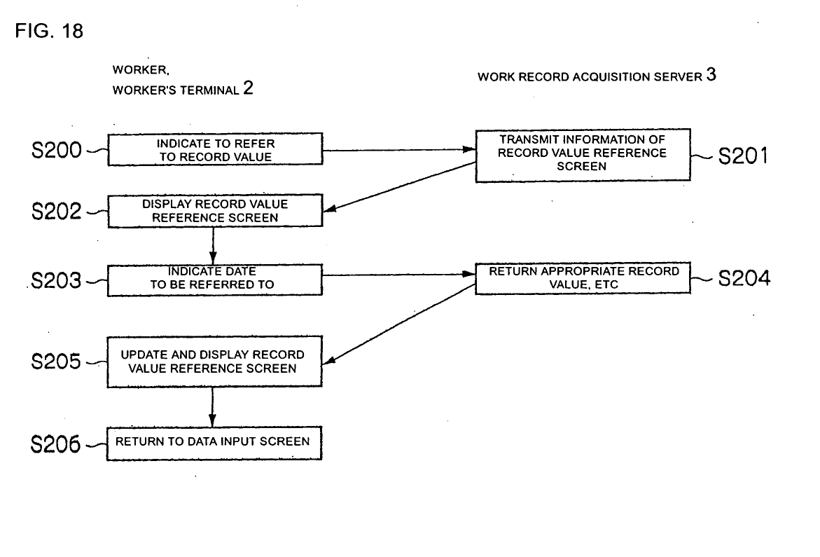

FIG. 18 is a sequence diagram showing the flow of the operation of the work record acquisition system 1 when the worker confirms his or her work record. The following explanation will be made on the assumption that the worker is an ordinary worker.

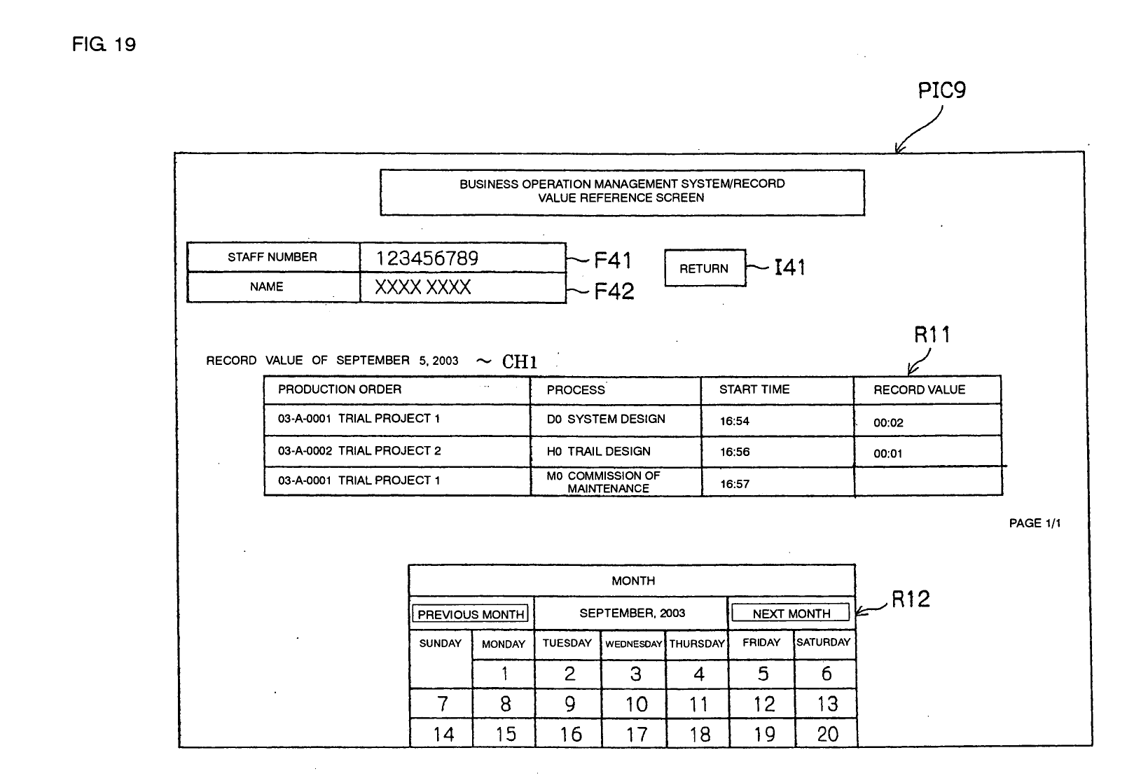

When the worker desires to confirm his or her work record in the work record file P24, he or she manipulates the “reference to record value” icon I4 in the data input screen. At the time, the worker's terminal 2 transmits the information of the manipulation and the like to the work record acquisition server 3 (S200). On receiving the information of the manipulation and the like, the work record acquisition server 3 reads out the work record of the day from the work record file P24 using the employee number of the worker as a key by the functions of the working hour calculation/storage subsection P14 and the initial information display subsection P12 thereof (at the time, the production number master file P22 and the work content master file P23 are appropriately referred), creates the information of a record value reference screen PIC9 as shown in FIG. 19, transmits the information to the worker's terminal 2, and displays it thereon (S201, S202).

The record value reference screen PIC9 shown in FIG. 19 includes display fields F41 and F42 for displaying the specific information of a worker such as a staff number, a name, and the like, further includes the display character string CH1 of the date of a work record being displayed, and further includes a table type record value display region R11 for displaying record values. Each row of the record value display region R11 shows one work record, and an order for production (production number and production name), a process (work number and work contents), a start time, and a record value (working hours) are displayed therein. In the example of FIG. 19, since a final work is not finished, a record value is not shown.

Note that the start time, which is registered by manipulating the “registration of business operation start time” icon I3 of the data input screen, is displayed in a color different from that of the start time, which is added and changed through record value edit processing to be described later so that the former start time can be discriminated from the latter start time.

The record value reference screen PIC9 includes a calendar display region R12. When the worker desires to confirm the work record of a past date, he or she manipulates the icon in the calendar display region R12 to specify the date. At the time, the worker's terminal 2 transmits the information of the data and the like to the work record acquisition server 3 (S203). On receiving the information of the date and the like, the work record acquisition server 3 reads out the work record of the specified date using the employee number of the worker as a key by the functions of the working hour calculation/storage subsection P14 and the initial information display subsection P12 thereof (at the time, the production number master file P22 and the work content master file P23 are appropriately referred), creates information for updating the display of the record value reference screen PIC9, transmits the information to the worker's terminal 2, and displays the record value reference screen including the work record of the date thereon (S204, S205). When the work record acquisition server 3 transmits the information of an initial record value reference screen PIC9 to the worker's terminal 2, the data of the past record information may be also transmitted, and when it is desired to display the work record of a past date, the record reference screen may be updated by executing processing on the worker's terminal 2 side only.

Since the record value reference screen (PIC9 and the like) is composed of a plurality of pages depending on the amount of data of a work record per day, the screen is additionally provided with a “next page” icon, a “previous page” icon, a “scroll” icon, and the like (not shown) so that a displayed page can be changed.

When a date is designated using the calendar display region R12, the designation of a future date may be refused or may be allowed. In the latter case, the record value display region R11 remains blank.

The record value reference screen (PIC9 and the like) is provided with a “return” icon I41, and when the “return” icon I41 is manipulated by the worker, the worker's terminal 2 returns a display to the data input screen (S206).

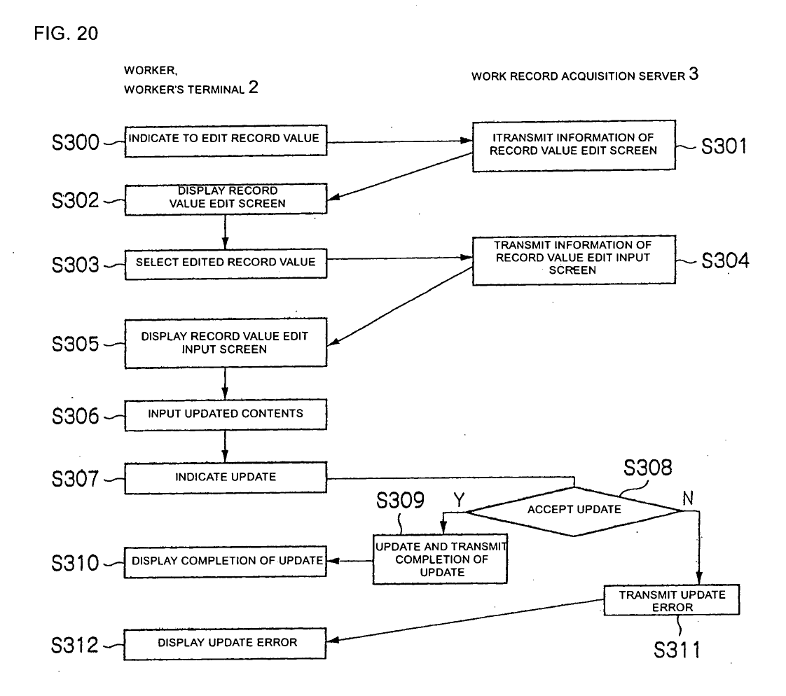

FIG. 20 is a sequence diagram showing the flow of the operation of the work record acquisition system 1 when the worker corrects his or her work record.

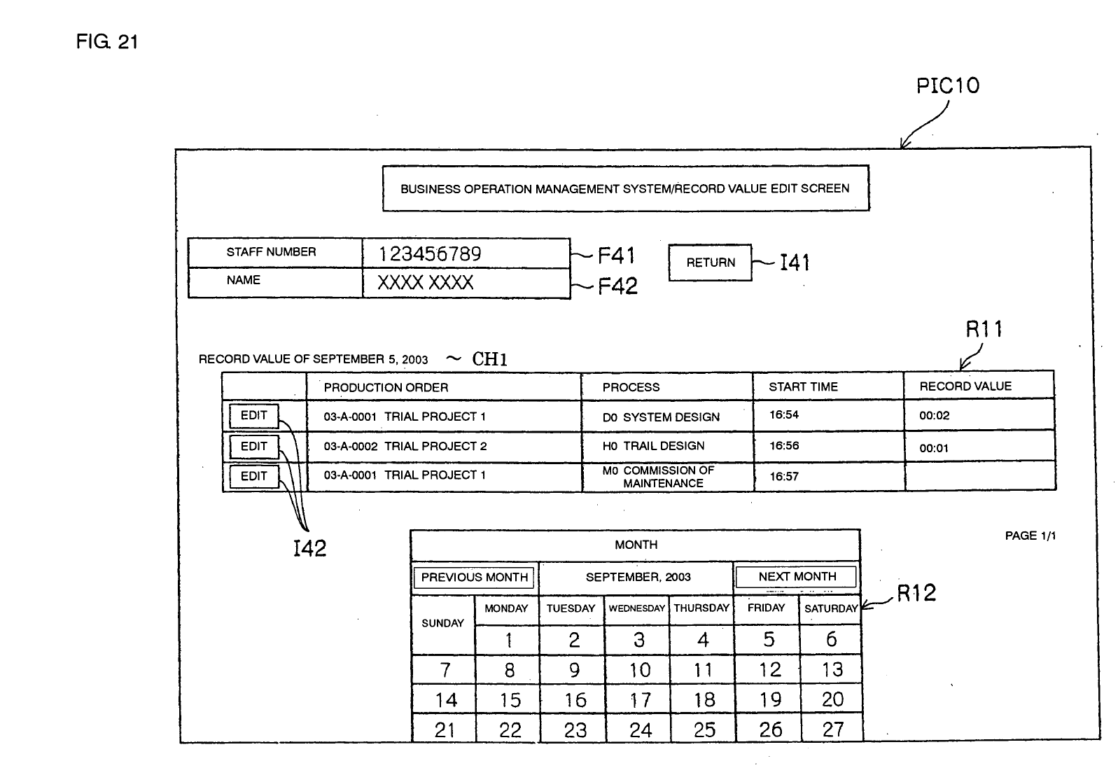

When the worker desires to correct (insert, change, delete) his or her work record, if the worker is an ordinary worker, he or she manipulates the “edit record value” icon I5-1 in the data input screen. At the time, the worker's terminal 2 transmits the information of the manipulation and the like to the work record acquisition server 3 (S300). On receiving the information of the manipulation and the like, the work record acquisition server 3 reads the work record of the day from the work record file P24 using the employee number of the worker as a key by the function of the working hour calculation/storage subsection P14 and the initial information display subsection P12 (at the time, the production number master file P22 and the work content master file P23 are appropriately referred), creates the information of a record value edit screen PIC10 as shown in FIG. 21, transmits the information to the worker's terminal 2, and displays it thereon (301, S302).

The record value edit screen PIC10 shown in FIG. 21 has an arrangement approximately similar to that of the record value reference screen PIC9 shown in FIG. 19. Note that the portions in FIG. 21, which correspond to those in the record value reference screen PIC9 shown in FIG. 19, are denoted by the same reference numerals. The record value edit screen PIC10 is different from the record value reference screen PIC9 in that an “edit” icon I42 is caused to correspond to the respective rows of the record value display region R11.

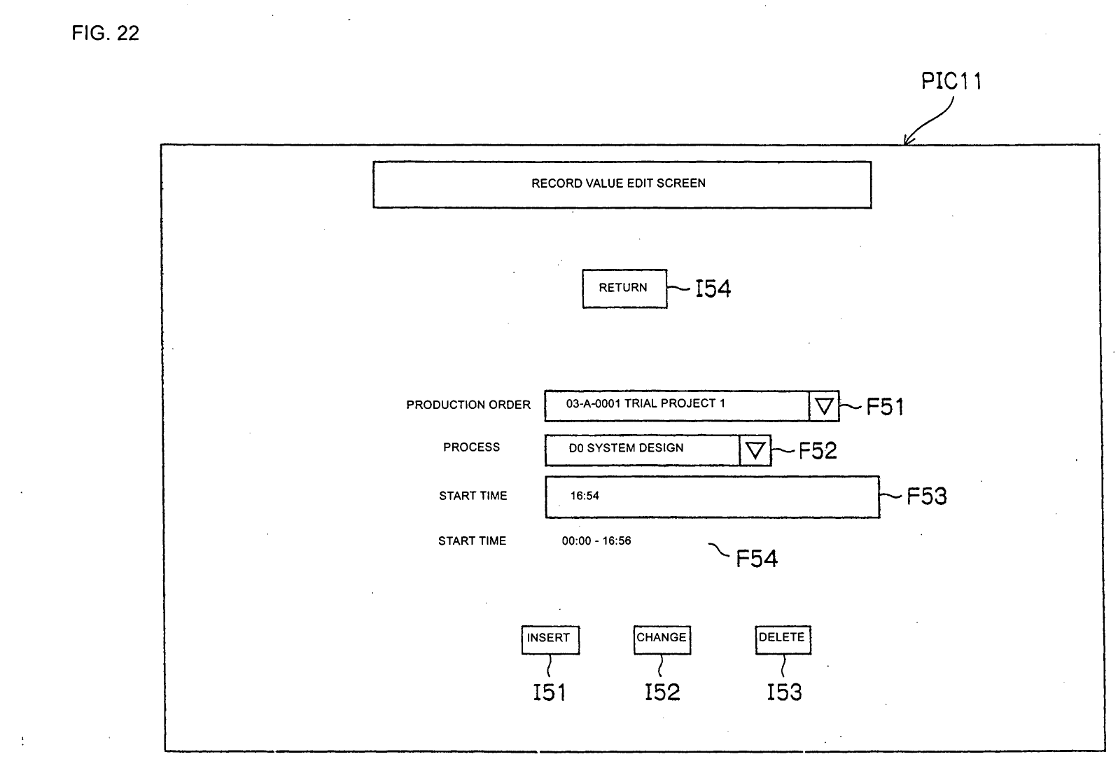

When the worker desires to change or delete a record value, he or she manipulates the “edit” icon I42 of a pertinent row, and when the worker desires to insert a record value, he or she manipulates the “edit” icon I42 of the row just below the row to which the record value is inserted. At the time, the worker's terminal transmits the information of the manipulation and the like to the work record acquisition server 3 (S303). On receiving the information of the manipulation and the like, the work record acquisition server 3 creates the information of a record value edit input screen PIC11 as shown in FIG. 22 which includes the work record of a designated row by functions of the working hour calculation/storage subsection P14 and the initial information display subsection P12 thereof, transmits the information to the worker's terminal 2, and displays it thereon (S304, S305).

The record value edit input screen PIC11 includes input display fields F51, F52, and F53 of the order for production (production number and production name), the process (work number and work contents), and the start time as well as a display field F54 having a time interval that can change the start time. The data of the input display fields F51, F52, and F53 of the order for production, the process, and the start time can be appropriately changed (S306). The time interval of the input display field F54 is displayed as the time interval from the start time of the row, in front of the row of the record value display region R11 in which the “edit” icon I42 is manipulated (when the previous row does not exist, 0:00), to the start time of a next row (when the next row does not exist, 24:00). The start time registered by manipulating the “business operation start time registration” icon I3 of the data input screen is displayed by a color different from that inserted and changed through the record value edit processing also in the display of the input display field F54 of the start time so that the causes why they are registered can be discriminated. An ordinary employee cannot be change the start time of the input display field F53 which is registered by manipulating the “registration of business operation start time” icon I3.

Further, the record value edit input screen PIC11 includes an “insertion” icon 151, a “change” icon 152, a “delete” icon 153, and a “return” icon 154.

When the “return” icon 154 is manipulated, the worker's terminal 2 (the worker's terminal 2 and the work record acquisition server 3) returns the display to the record value edit screen PIC10 as shown in FIG. 21, although the processing is omitted in FIG. 20.

The worker manipulates the icon I51, I52, or I53 that relates to a desired edit type. At the time, the worker's terminal 2 transmits the information of the manipulation and the like to the work record acquisition server 3 (S307). On receiving the information of the manipulation and the like, the work record acquisition server 3 first determines whether or not the edit can be accepted by the functions of the working hour calculation/storage subsection P14 and the initial information display subsection P12 (S308). When the edit can be accepted, the work record file P24 is updated according to the designated contents of the edit, the information of an edit registration finish screen (not shown) is created and transmitted to the worker's terminal 2, and the information is displayed on the edit registration finish screen (S309, S310). In contrast, when the edit cannot be accepted, the information of an edit registration error screen (not shown) is created and transmitted to the worker's terminal 2, and the edit registration error screen is displayed thereon (S311, S312).

Note that not only the work record of the row whose edit is directly indicated but also the work record of other row are updated depending on the contents of the edit. When, for example, the start time of the process of a row is corrected to the time two minutes earlier than the above time, not only the start time and the working hours of the row are updated but also the working hours of the row just in front of the above row is also updated so that they are reduced two minutes.

Although illustration is omitted, the edit registration finish screen includes a message indicating that edit registration has been finished (for example, “insertion has been finished”) and a “return” icon, and the display returns to a record value edit screen to which the contents of the edit is reflected (this screen is the same as the record value edit screen PIC10 except that the contents of the edit are reflected thereto) by manipulating the “return” icon. The record value edit screen, to which the contents of the edit are reflected, may be displayed by causing the worker's terminal 2 and the work record acquisition server 3 to receive and transmit data therebetween by manipulating the “return” icon. Otherwise, the record value edit screen may be displayed by the processing executed by only the worker's terminal 2 when the “return” icon is manipulated by transmitting the information for displaying the record value edit screen, to which the contents of the edit are reflected, when the information of the edit registration finish screen (not shown) is transmitted.

Further, when the information of the edit registration finish screen or the information of the record value edit screen, to which the contents of the edit are reflected, is transmitted to the worker's terminal, or when the following condition is established at a timing before or after the transmission of the above information, the work record acquisition server 3 transmits information that makes the “today's business operation finished” icon I7 of the data input screen displayed thereafter valid again. That is, when a record value edit is started and the information of a final work including only a start time (not including working hours) is inserted after the “today's business operation finished” icon I7 has been manipulated on the day and the record value of the final work has been stored in the work record file P24, the “today's business operation finished” icon I7 is made valid again.

The edit registration is rejected in, for example, the following cases in the determination of whether or not the edit described above is accepted (S308):
(a) when the start time to be inserted or to be changed is not within the allowable range of the start time;
(b) when the start time to be inserted or to be changed matches the start time of other process;
(c) when the start time of the process registered by manipulating the “registration of business operation start time” icon I3 is changed (however, the change of an order for production and a process is accepted); and
(d) when the work record of a process registered by manipulating the “registration of business operation start time” icon I3 is deleted.

Although the case that the ordinary employee desires to edit a record value has been explained above, the above items of refusal (c) and (d) are the items of refusal typical to the case of the ordinary embodiment. For example, the items (c) and (d) are not the items of refusal in the edit of the record value of a management-level employee and a system manager, and only the items (a) and (b) are the items of refusal to them. Since the record value edit operation of the management-level employee and the system manager is the same as that of the ordinary employee except the above point, the explanation thereof is omitted.

The not shown edit registration error screen includes an error message, indicating that edit registration cannot be executed (the contents of the message are different depending on the items of refusal described above), and a “return” icon, and the display is returned to the record value edit screen (for example, PIC10) before the edit is indicated by manipulating the “return” icon. The record value edit screen, to which the contents of the edit are not reflected, may be displayed by causing the worker's terminal 2 and the work record acquisition server 3 to receive and transmit data therebetween by manipulating the “return” icon. Otherwise, the record value edit screen may be displayed by the processing executed by only the worker's terminal 2 when the “return” icon is manipulated by transmitting the information for displaying the record value edit screen, to which the contents of the edit are not reflected, when the information of the edit registration error screen (not shown) is transmitted.

A management-level employee and a system manager (employee for managing the system) can edit the work record of a subordinate employee or a managed person, respectively. Since the management-level employee and the system manager execute the same operation to edit the work record, an example of the operation executed by the management-level employee to edit the work record of the subordinate employee will be explained below.

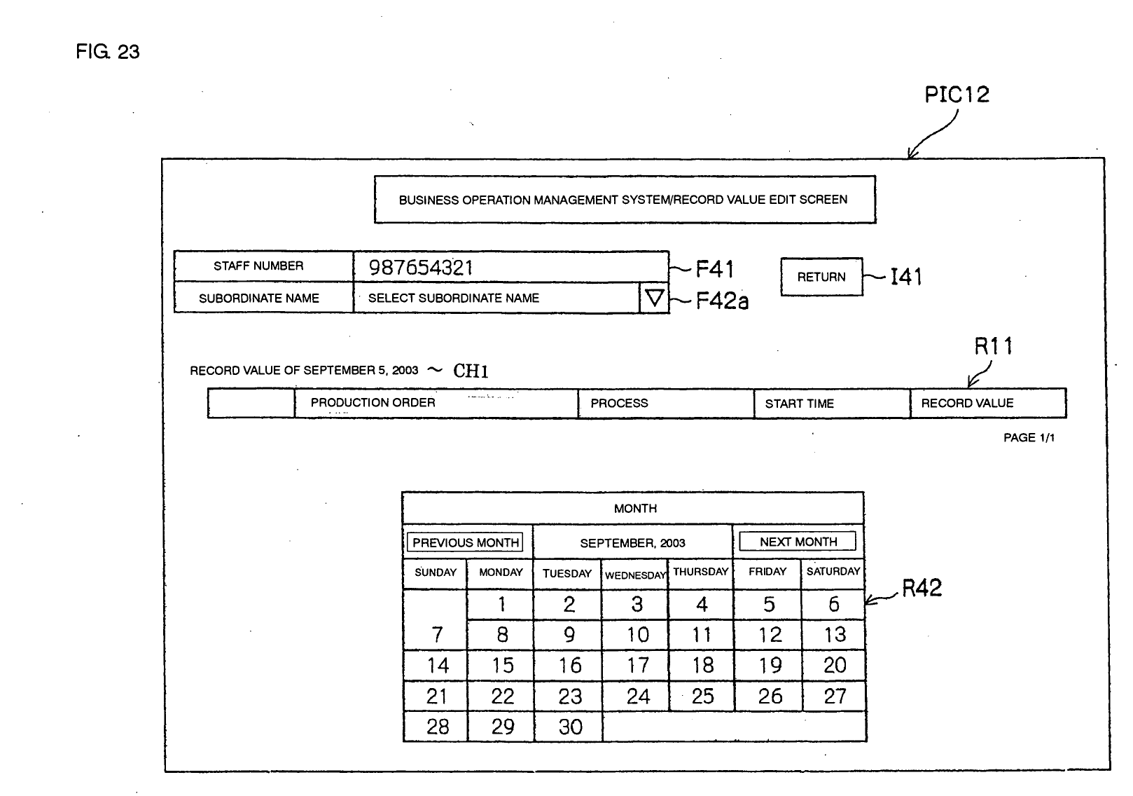

When the management-level employee edits the work record of the subordinate employee, he or she manipulates the “edit record value of subordinate” icon I6 in the management-level employee data input screen PIC3. Although a sequence diagram is omitted, this is notified from the worker's terminal 2 to the work record acquisition server 3 at the time, the work record acquisition server 3 returns the information of a subordinate record value edit screen PIC12 as shown in FIG. 23, and displays it on the worker's terminal 2.

The subordinate record value edit screen PIC12 shown in FIG. 23 is the same as the record value edit screen PIC10 shown in FIG. 21 (the portions in FIG. 23 corresponding to those in FIG. 21 are denoted by the same reference numerals) except that the name display field 42 of the latter screen is changed to a subordinate name input display field F42a. Since a subordinate is not specified at this stage, the record value display region R11 remains blank, and the “edit” icon I51 is not also displayed.

When the management-level employee inputs a subordinate name to the subordinate name input display field F42a, the information of the name and the like is transmitted from the worker's terminal 2 to the work record acquisition server 3. The work record acquisition server 3 takes out the work record on a pertinent day of a pertinent subordinate from the work record file P24 and returns the work record to the worker's terminal 2. The worker's terminal 2 returns the information of the subordinate record value edit screen PIC12 as shown in FIG. 23 and displays a subordinate record value edit screen (although omitted, it is similar to that shown in FIG. 21), the screen having the work record inserted into the record value display region R11 and “edit” icons disposed to respective rows.

Thereafter, an operation, which is similar to that of the case in which an ordinary employee edits his or her work record will be executed. However, the operation of the management-level employee is that the edit is limited only to “insertion,” although “change” and “delete” are not admitted.

According to the first embodiment described above, the work record can be basically obtained by that the worker only selects a process (work) and indicates to start a business operation after log-in, thereby the load on the worker in the operation for acquiring the work record can be reduced. Further, the work record of a previous work can be acquired from the server in real time by indicating the start of the business operation. Furthermore, since the start of the business operation can be indicated only by manipulating the mouse unit, usability can be enhanced as well as a feeling of resistance of the worker against the operation for indicating the start of the business operation can be eased.

Further, according to the first embodiment described above, since the worker can execute the log-in only by executing the fingerprint read operation, the worker can be securely recognized.

According to the first embodiment described above, since the information during work is displayed in the reduced window screen while the worker's terminal is used by other application program, the worker can easily confirm whether or not he or she executes an input operation for acquiring the work record as well as can prevent to execute an input twice to the same work.

Further, since the reduced window screen includes the icon for returning the screen to the data input screen for inputting the work record, the display can be easily returned to the data input screen for inputting the work record, which considerably enhances the reliability for the indication of the start of a next work.

(B) Second Embodiment

Next, a second embodiment of the work record acquisition system, the work record acquisition server, and the work record acquisition program according to the present invention will be explained mainly as to the difference between the second embodiment and the first embodiment with reference to the drawings.

An employee confirmation method of the second embodiment by which a work record acquisition server 3 is permitted to transmit data screen input information at step S8 of FIG. 8 is different from that of the first embodiment.

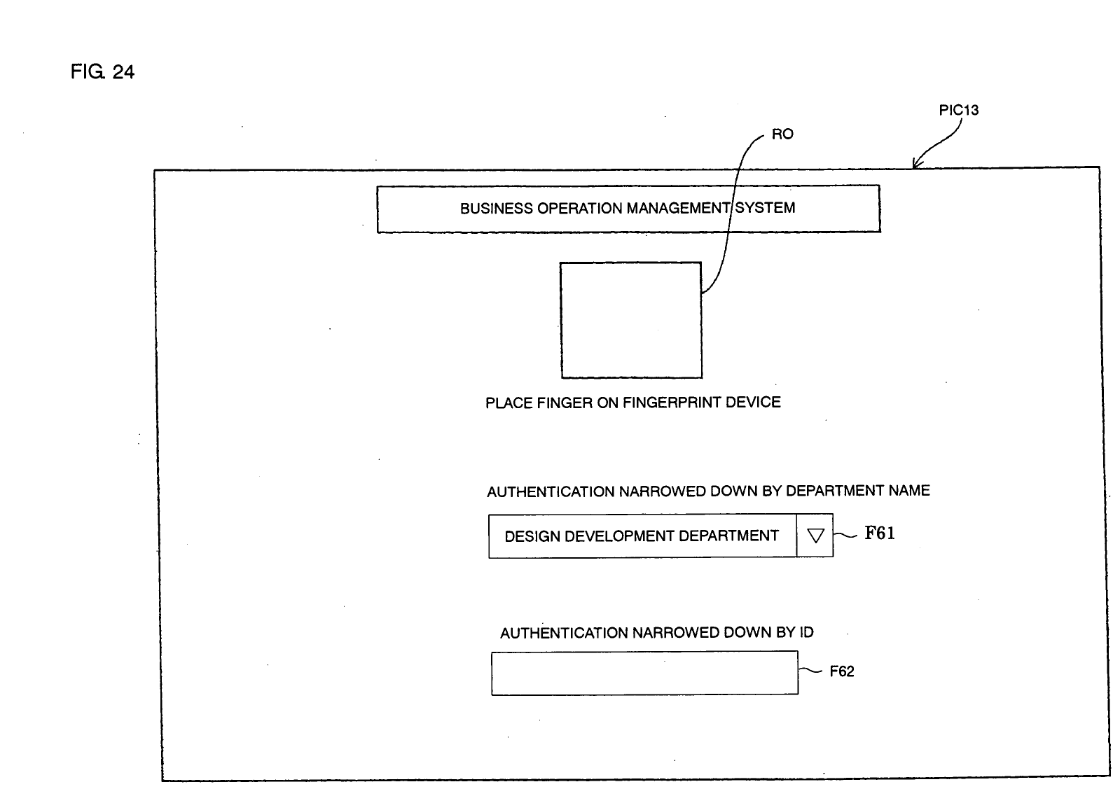

FIG. 24 is a view explaining a log-in screen PIC13 of the second embodiment and corresponds to FIG. 9 showing the log-in screen PIC1 of the first embodiment.

The log-in screen PIC13 of the second embodiment includes a department name input display field F61 and an employee number (ID) input display field F62, in addition to a fingerprint display region R0 for displaying fingerprint data read and acquired by a fingerprint reader 2A.

The department name input display field F61 is an input display field in which an employee who desires to log in a work record acquisition program P selects the name of the department to which he or she belongs by a menu system. The department name input display field F61 may initially display the department name of an employee who is assumed and determined by the work record acquisition server 3 or may display the department name that was input in the last log-in through the terminal of the display field F61. When a worker's terminal 2 transmits data to the work record acquisition server 3 to take out, for example, the information of the log-in screen PIC13, the worker's terminal 2 transmits the data together with ID data specific to the terminal (terminal ID). In response to the transmission of the data, the work record acquisition server 3 determines department name data to be displayed initially by assuming the employee or recognizing the terminal. In this case, a new file must be stored in a data storage section P2 or data must be added to an existing file for the above purpose.

The employee number input display field F62 is an input display field to which the employee, who desires to log in the work record acquisition program P, inputs his or her employee number (it may be other ID information). The employee number input display field F62 may initially display the employee number of an employee which is assumed and determined by the work record acquisition server 3 by the method described above or may display the employee number that was input in the last log-in through the terminal of the display field F62.

In the second embodiment, when there exists one type of data including the fingerprint data of three types of data, i.e. the fingerprint data, the department name data, and the employee number data, the employee indicates to transmit the data to the work record acquisition server 3 by manipulating an “execution” key and the like of a keyboard. When the department name data and the employee number data are input, it may be taught to the employees in a manual to input the data before a fingerprint is read, and when the fingerprint data is acquired, it may be automatically transmitted to the work record acquisition server 3. With the above operation, it can be guaranteed that the fingerprint data is included in the data for authentication.

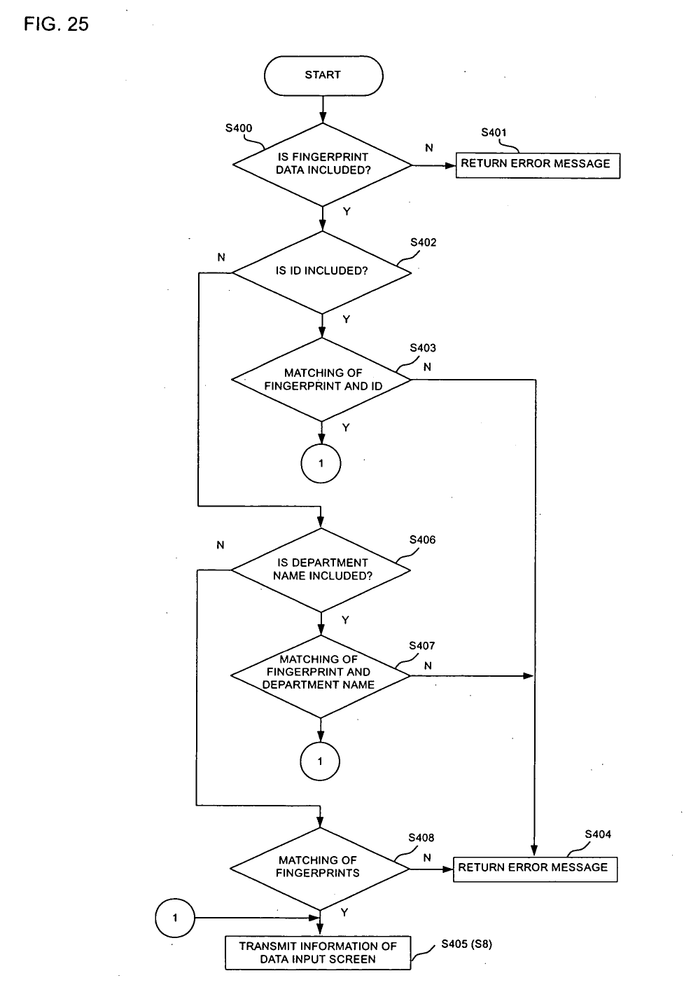

When the input data relating to the log-in screen PIC13 is supplied to the work record acquisition server 3, the server 3 executes processing as shown in the flowchart of FIG. 25.

The work record acquisition server 3 first determines whether or not the fingerprint data is included in the input data supplied thereto (S400). When the fingerprint data is not included in the input data, an error message indicating that necessary data is not complete is returned to the worker's terminal (S401).

When the fingerprint data is included in the input data, the work record acquisition server 3 determines whether or not the employee number data is included in the input data supplied thereto (S402), and when the employee number data is included in the input data supplied thereto, log-in is authenticated based on the fingerprint data and the employee number data (S403). When a group of the fingerprint data and employee number data supplied thereto does not exist in the registered groups of the data when they are recognized as a group, the work record acquisition server 3 returns an error message indicating that the log-in could not be authenticated to the worker's terminal 2 (S404). In contrast, when the group of the fingerprint data and employee number data supplied thereto exists in the registered groups of the data, the work record acquisition server 3 executes processing in authentication such the transmission of the data input screen, and the like (corresponding to S405, S408 of FIG. 8, and the like).

Even if all of the three types of the data, i.e. the fingerprint data, the fingerprint data, and the employee number data are included in the input data, the log-in is authenticated based on the fingerprint data and employee number data at step S403, and this case is the same as that in which the department name data does not exist.

When the employee number data is not included in the input data, the work record acquisition server 3 determines whether or not the department number data is included in the input data supplied thereto (S406), and when the department number data is included in the input data, the log-in is authenticated based on the fingerprint data and department number data (S407). In this case, when a group of the fingerprint data and department number data does not exist in the registered groups of the data, the work record acquisition server 3 returns an error message indicating that the log-in could not be authenticated to the worker's terminal 2 (S404), whereas when the group of the fingerprint data and employee number data exist in the registered groups of the data, the work record acquisition server 3 executes the processing in authentication such the transmission of the data input screen, and the like (S405).

When the department number data is not included in the input data, the work record acquisition server 3 authenticates the log-in based on only the fingerprint data (S408). In this case, when the fingerprint data does not exist in the registered fingerprint data, the work record acquisition server 3 also returns an error message indicating that the log-in could not be authenticated to the worker's terminal 2 (S404), whereas when the fingerprint data exists in the registered fingerprint data, the work record acquisition server 3 executes the processing in authentication such the transmission of the data input screen information, and the like (S405).

As apparent from the authentication described above, a first priority is given to the authentication executed based on the fingerprint data and employee number data, a second priority is given to the authentication executed based on the fingerprint data and department number data, and a third priority is given to the authentication executed based on only the fingerprint data, that is, a higher priority is given to the authentication which is narrowed down by the data other than the fingerprint data. The authentication, which is more narrowed down by the data other than the fingerprint data, may be provided with a more loose reference for determining matching when the fingerprint data is identified, and this reference may be variably set by a system manager.

The same processing as that of the first embodiment can be executed also in the second embodiment except the processing described above.

According to the second embodiment, there can be achieved an effect that an operator (employee) of the worker's terminal 2 can arbitrarily select a method of authenticating him or her, in addition to the same effect as that of the first embodiment. For example, a person whose unmatching is determined by the authentication executed only by the fingerprint data regardless of that he or she is an authorized person can more easily authenticated when the identification of him or her is executed using other data together with the fingerprint data. Since the data other than the fingerprint data used for authentication is already stored in the work record acquisition server 3, a storage file and the like do not become complex.

(C) Third Embodiment

Next, a third embodiment of the work record acquisition system, the work record acquisition server, and the work record acquisition program according to the present invention will be explained mainly as to the difference between the third embodiment and the first embodiment with reference to the drawings. Note that the group of the production number and the production number, which is expressed as the “order for production” in the first embodiment, is expressed as a “project”, in the third embodiment.

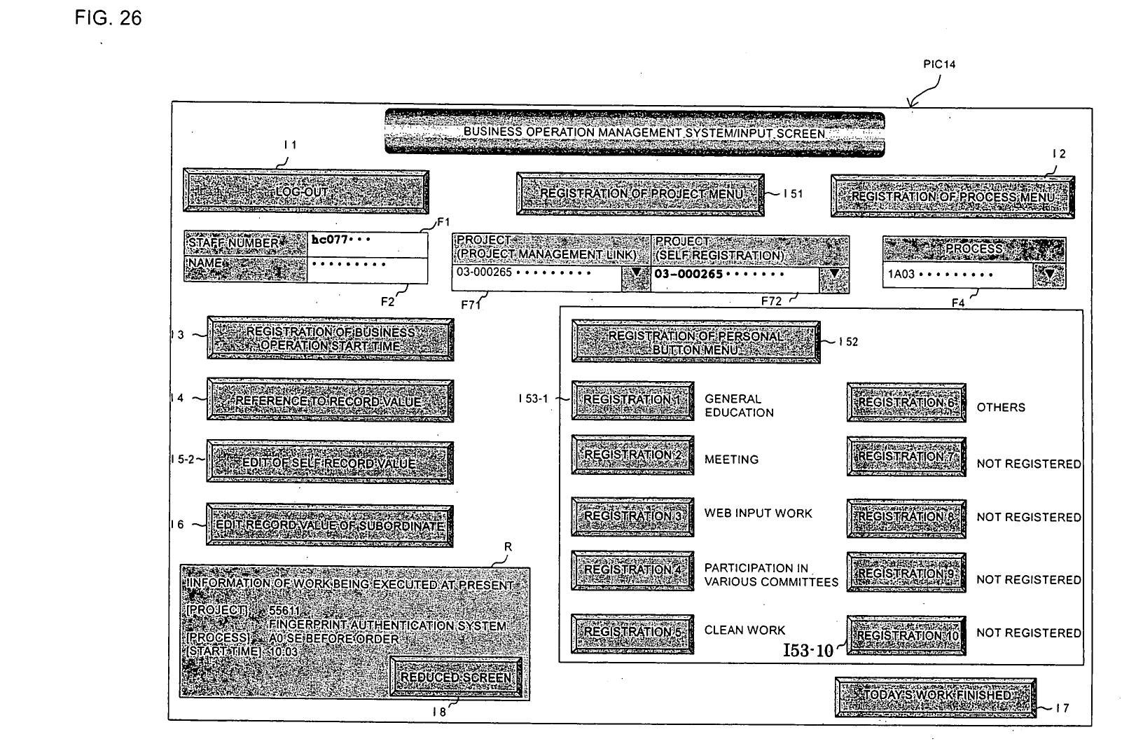

FIG. 26 is an explanatory view showing a management-level employee data input screen PIC14 of the third embodiment, and the portions in FIG. 26, which are the same as or correspond to those of FIG. 11 showing the first embodiment, are denoted by the same reference numerals. Although an ordinary employee data input screen and a system manager data input screen are omitted in the third embodiment, the ordinary employee data input screen is different from that shown in FIG. 26 in that it is provided with a “edit record value of subordinate” icon 16 to the data input screen PIC14, and the system manager data input screen is provided with a “edit record value of managed person” icon in place of the “edit record value of subordinate” icon I6.

The explanation of the third embodiment omitted because it is approximately the same as the first embodiment mainly except the following four point:

(1) since the alternatives of a process are arranged hierarchically, processing steps for selecting and registering processes are arranged according to the hierarchy; (2) a project (order for production) is also a subject which can be registered by management-level employees and ordinary employees; (3) an input display field through which a project is selected is divided into a field used to projects registered by individuals and a field through which all the employees can select projects; and (4) management-level employees and ordinary employees can register groups of projects (orders for production) and processes and can appropriately select them.

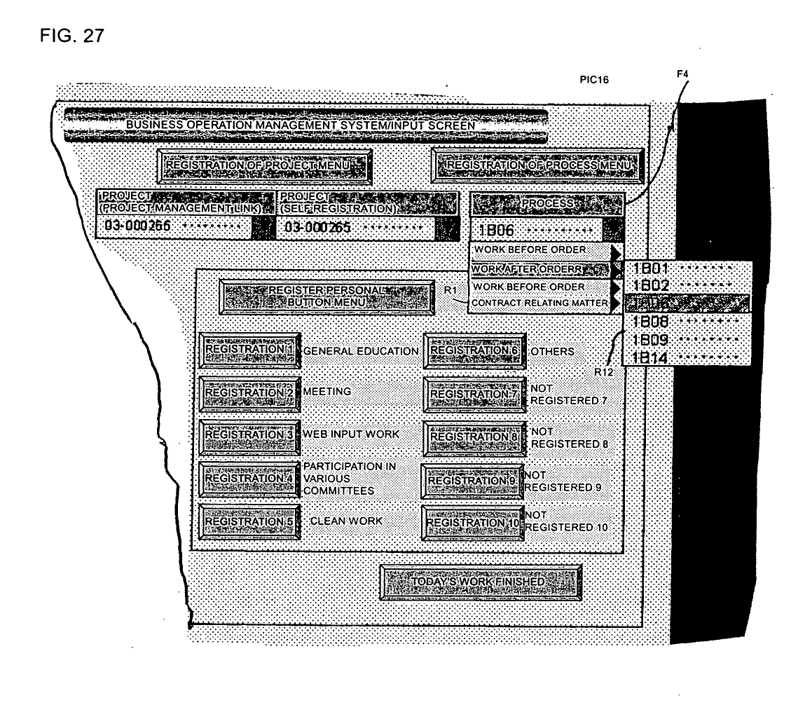

FIG. 27 is an explanatory view showing a modified screen PIC15 (only the main portion thereof) of the data input screen PIC14 shown in FIG. 26 after a menu display start icon at the right end of an input display field F4 of the data input screen PIC14 is depressed and further an alternative of an upper hierarchy is selected.

As shown in FIG. 27, when the menu display start icon at the right end of the input display field F4 is depressed, a plurality of process group names of an intermediate hierarchy of a process are displayed as alternatives (display region R21). When the name of any one of the process groups is clicked, the groups of the process numbers and process names of all the processes belonging to the process group of the intermediate hierarchy are displayed as alternatives (display region R22). When any one of the groups of the process numbers and process names is clicked, the group of the process number and process name is displayed in the input display field F4.

Although illustration is omitted, in the third embodiment, the internal arrangement of a work content master file P23 can cope with the hierarchy processing described above.

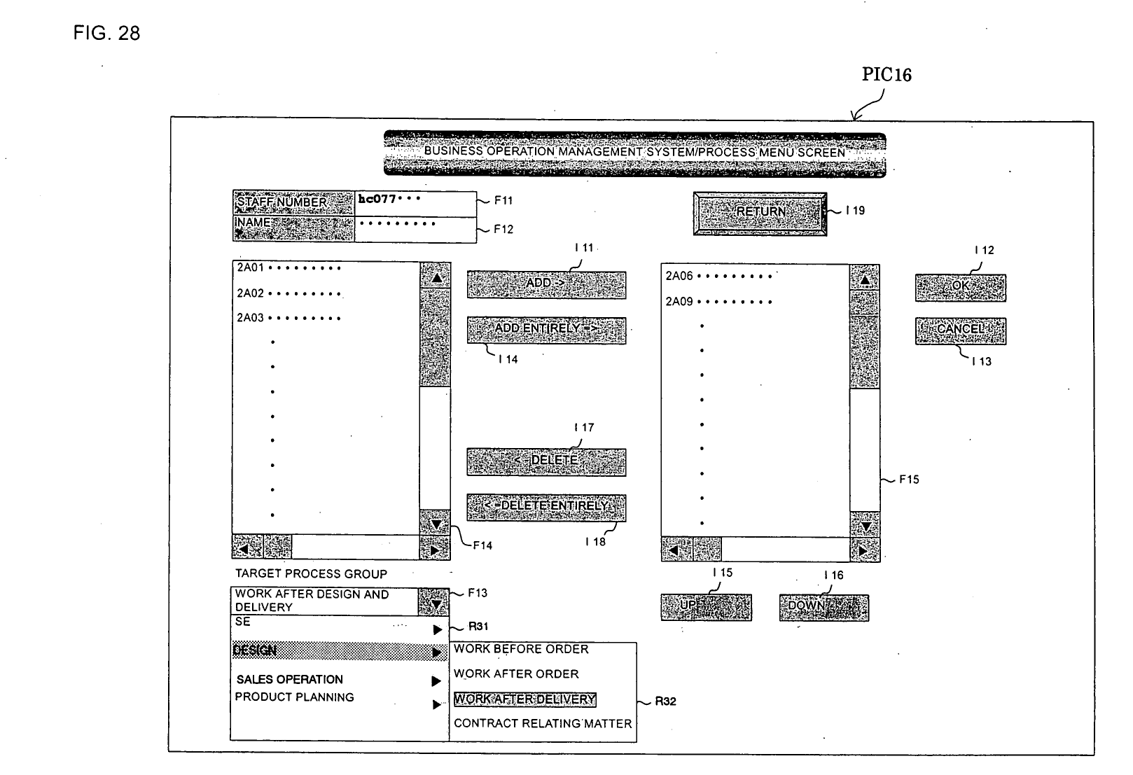

FIG. 28 is an explanatory view showing a process menu screen PIC16 of the third embodiment and corresponds to FIG. 12 showing the process menu screen PIC4 of the first embodiment, and the components in FIG. 28 that are the same as or correspond to those in FIG. 12 are denoted by the same reference numerals.

The contents displayed in the process menu screen PIC16 immediately after the process menu screen PIC16 is displayed are the same as those in the first embodiment (process menu screen PIC4) also in the third embodiment.

In the third embodiment, a process group name input display field F13 displays, for example, a group of a department name (process group name of an upper hierarchy) and a type of work (the process group name of an intermediate hierarchy). When a menu display start icon at the right end of the input display field F13 is manipulated, the names of the process groups of the upper hierarchy are displayed as alternatives (display region R31). When any one of the names of the process groups of the upper hierarchy is clicked, the names of the process groups of the intermediate hierarchy belonging to the process group of the upper hierarchy are displayed as alternatives (display region R32). When any one of the names of the process groups of the intermediate hierarchy is clicked, the input display field F13 displays the names of the process group of the upper hierarchy and the names of the process groups of the intermediate hierarchy together. Further, the input display field F14 displays a list of the processes (work contents) belonging to the process groups prescribed by the names of the process groups of the upper and intermediate hierarchies.

The other processing steps of the third embodiment as to the registration of a process menu are the same as those of the first embodiment. However, the information of a process, which is displayed in an input display field F15 and registered to an individual (employee) by manipulating an “OK” icon I12 is also accompanied with the name of the process group of the intermediate hierarchy.

Returning to FIG. 26, the third embodiment includes two input display fields I71 and I72 as input display fields for displaying a project (order for production).

The input display field I72 is a field for displaying the groups of the project numbers and the project names registered by an employee relating to the data input screen PIC14 and can selectively display the information of one of the plurality of registered projects. The input display field I71 is a field that also displays the information of the projects registered by any of the employees, in addition to the information of the projects initially prepared by the work record acquisition system.

When, for example, a certain employee is taken into consideration, he or she can more easily select the projects, which were registered by him or her, in the input display field I72 because the field has a smaller numbers of alternatives. However, the projects cannot be selected using the input display field I72 unless they are registered, and thus the input display field I71 is used in selection. Note that both the input display fields I71 and I72 display the information selected just previously as long as they are not selected.

To permit the display of the information of the two types of the projects as described above, the third embodiment is provided with, for example, registered project information files prepared for respective employees (not shown) and a system project information file for storing and managing the project information of an overall system (not shown).

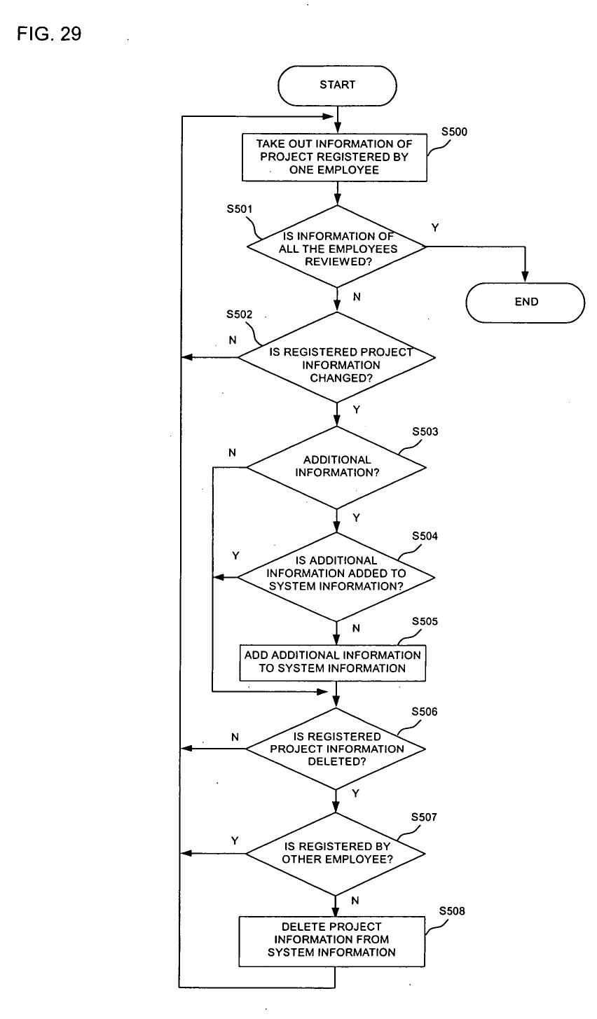

FIG. 29 is a flowchart showing processing for reflecting the registered project information of the respective employees to the system project information. A functional section for executing the processing may be an initial information display subsection P12 or may be a functional section that is newly provided separately and properly called, for example, a project management section (in the processing described hereinafter, the project management section acts as a main body of the processing).

The project management section starts processing shown in FIG. 29 at every predetermined cycle (for example, once a day at AM 0:00). First, the project management section executes an operation for taking out the information of the registered projects of an employee (S500), and confirms that information review processing for all the employees is not yet finished (S501). When the information review processing for all the employees has been finished, the project management section finishes a series of processing steps shown in FIG. 29.

When the registered project information of an employee is taken out, it is determined whether or not the registered project information is changed from previous registered project information (S502). When it is not changed, the flow returns to the step S500 described above.

When the registered project information is changed from the previous one, it is determined whether or not there is additional information as registered project information having been changed (S503). When there is the additional information, it is determined whether or not it has been registered as the system project information (S504), whereas when it is not yet registered, the additional information is also added to the system project information (S505).

When there is no additional information as the registered project information having been changed, or when there is additional information which has been registered to the system project information or subjected to additional processing, it is determined whether or not there is any registered project information deleted as registered project information having been changed from previous one (S506). When there is any registered project information that has been deleted, it is determined whether or not the registered project information is registered by other employee (S507), and when it is not registered by other embodiment, it is also deleted from the system project information (S508).

When there is no deleted information as the registered project information having been changed, or when there is deleted information which has been registered by other embodiment or subjected to delete processing, the flow returns to the step S500 described above.

The registered project information of the respective employees is also included in the system project information so that it can be referred to by other employees taking it into consideration that there is a work which is executed by a plurality of employees who cooperate with each other. In other words, this is to permit a worker to utilize the information registered by a cooperating worker even if he or she does not register the information.

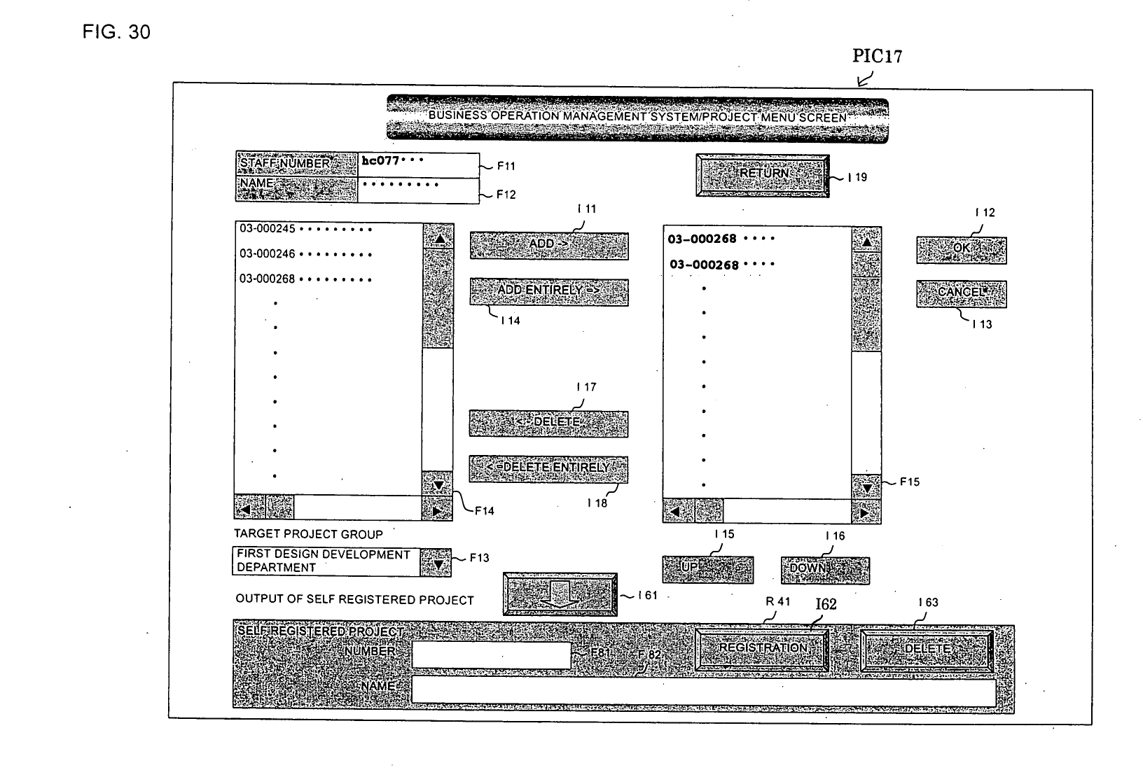

A “registration of project menu” icon I51 in the data input screen PIC14 shown in FIG. 26 is used to start processing for permitting an employee to register project information by himself or herself. When the “registration of project menu” icon I51 is manipulated, a project menu screen PIC17 shown in FIG. 30 is displayed. More specifically, it is notified from a worker's terminal 2 to a work record acquisition server 3 that the “registration of project menu” icon I51 is manipulated. In response to the notification, (the initial information display subsection P12) of the work record acquisition server 3 creates the information of the project menu screen PIC17 of a worker relating to the notification relating to the notification, notifies the information to the worker's terminal 2, and displays it thereon.

The project menu screen PIC17 shown in FIG. 30 is similar to the process menu screen PIC16 of the third embodiment shown in FIG. 28 in many portions, although the former screen creates (registers) a project menu and the latter screen creates (registers) a process menu. Thus, the portions of the project menu screen PIC17 that are the same as or correspond to those of the process menu screen PIC16 are denoted by the same reference numerals, and the explanation thereof is omitted.

In the project menu screen PIC17, the input display field F13 is not arranged as an input display field of a process group name and is arranged as an input display field of a project name. When a menu display start icon at the right end of the input display field F13 is manipulated, the names of project groups are displayed as alternatives (although not shown, displayed as a menu), and when any one of the alternatives is clicked, the name of the process group of the alternative is displayed in the input display field F13. Further, a list of the projects belonging to the project group prescribed by the name of the process group is displayed in the display field 14F. The respective departments are appropriate as the project group as well as a group of “self-registered projects” relating to the employees of the departments is also arranged as one project group.

The project menu screen PIC17 includes a self-registered project processing region R41 as well as includes a “output of self registered project” icon I61 that starts to transmit project information to the self-registered project processing region R41. The self-registered project processing region R41 includes a project number input display field F81, a project name input display field F82, a “registration” icon I62, and a “delete” icon I63.

Immediately after the “registration of project menu” icon I51 is manipulated and the project menu screen PIC17 is displayed, both the number and name input display fields F81 and F82 remain blank. When the “output of self registered project” icon I61 is manipulated at the time the project information of any of the display fields 14F and 15F is displayed by being applied with a cursor, the number and name of the project at which the cursor is located are displayed in the number and name input display fields F81 and F82. Further, it is also possible to locate cursors in the number and name input display fields F81 and F82 using a mouse and a keyboard in the state that these fields F81 and F82 are blank and to input the number and name of the project through keys thereafter. It is also possible to amend the number and name displayed in the fields F81 and F82 using the keyboard.

In the state that information is displayed in the number and name input display field F81 and F82, the manipulation of the “registration” icon I62 or the “delete” icon 162 can be accepted. When the above icon is manipulated, information for requesting the registration and delete of project information is transmitted from the worker's terminal 2 to the work record acquisition server 3, the work record acquisition server 3 executes registration or delete processing although not illustrated, and returns a result of the processing to the worker's terminal 2. The work record acquisition server 3 executes new registration in response to a request for registering project information having a new project number (it may have the same name) and executes amendment registration in response to a request for registering project information having the same project name as an existing project number. For example, when the project information, which is requested to be deleted, is registered, the work record acquisition server 3 executes delete processing. Note that the work record acquisition server 3 returns an error message to the worker's terminal depending on a result of the processing.

In FIG. 26, an “individual button menu registration” icon I52 is an icon for starting processing for personally registering a specific work composed of a combination of a project and a process in correspondence to a “registration 1” icon I53-1 to a “registration 10” icon I53-10.

When the “registration 1” icon I53-1 to the “registration 10” icon I53-10 are manipulated, they display project information (project number and name) that is caused to correspond to the these icons in an input display field F71 or F72 relating to the project information as well as displays process information (process number and name) that is caused to correspond to these icons in the input display field F4 relating to the process information, and registered information is displayed in correspondence to a registration name so that it can be easily understood. That is, a work to be executed from now can be easily designated and input by using the registration function. Note that FIG. 26 shows the state that information is registered in the “registration 1” icon I53-1 to the “registration 6” icon I53-6 and information is not yet registered in the “registration 7” icons I53-7 to the “registration 10” icon I53-10.

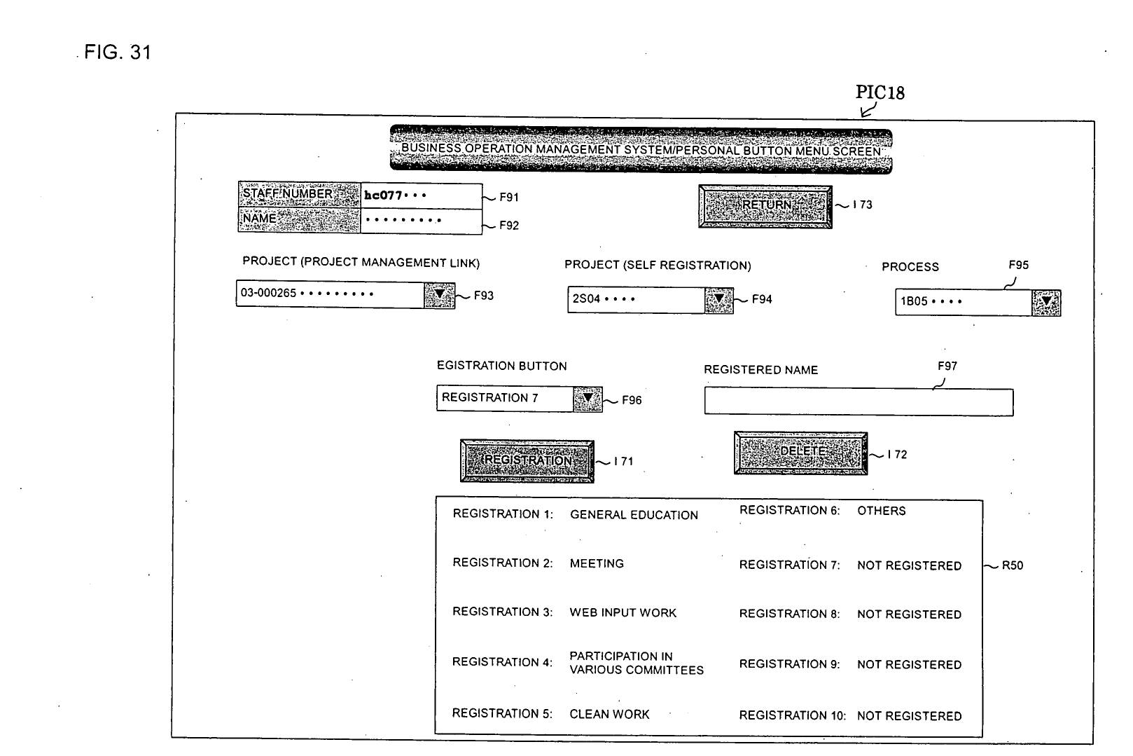

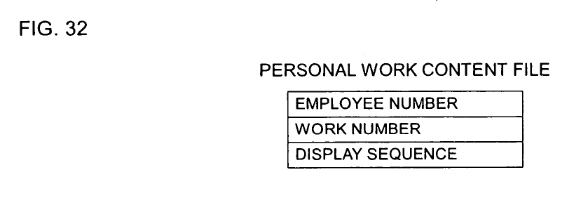

FIG. 31 is an explanatory view showing an example of a personal button menu screen PIC18 which is displayed when the “registration of individual button menu” icon I52 is manipulated. Note that when the work record acquisition server 3 transmits the information of the data input screen PIC14 to the worker's terminal 2, the server 3 may also transmit the information of the personal button menu screen PIC18 to the worker's terminal 2. Otherwise, when the manipulation of the “registration of individual button menu” icon I52 is notified from the worker's terminal 2 to the work record acquisition server 3, the server 3 may transmit the information of the personal button menu screen PIC18 to the worker's terminal 2.

The personal button menu screen PIC18 includes employee number and name display fields F91 and F92.

Further, the personal button menu screen PIC18 includes an input display field F93, which can select the information of the projects managed by the system, an input display field F94, which can select the project information registered (arranged as a menu) by the employee for personal use, and an input display field F95, which can select the process information registered (arranged as a menu) by the employee for personal use. That is, the project information (work contents), which is intended to register, is specified by making any one of the alternatives of the input display fields F93 and F94 valid, and the process information of the work contents, which is intended to register, is specified by making any one of the alternatives of the input display fields F93 and F94 valid.

The personal button menu screen PIC18 includes a display region R50 for clarifying the present registration state of the “registration 1” icons I53-1 to the “registration 10” icons I53-10. An input display field F96 is used to specify a registration icon (any one of the “registration 1” icons I53-1 to the “registration 10” icons I53-10) which corresponds to the information to be registered or to be deleted from now, and an input display field F97 is used to specify an identification name (registration name) for discriminating between the information to be registered and the information to be deleted.

The input display fields F96 and F97 remain blank immediately after the personal button menu screen PIC18 is displayed.

After valid information is input to the input display fields F96 and F97, new registration or amendment registration can be executed by manipulating a “registration” icon I71. Further, after valid information is input to the input display fields F96 and F97, registered information can be deleted by manipulating a “delete” icon I72.

For example, registered information as to the “registration 1” icons I53-1 to the “registration 10” icon I53-10 is the information stored in a personnel information master file P21 or the information of a file dedicated for the registered information. When the “registration” icon I71 or the “delete” icon I72 is manipulated, a request for registration or a request for delete is supplied from the worker's terminal 2 to the work record acquisition server 3, the server 3 executes registration processing or delete processing and returns a result of processing (sometimes, an error message) to the worker's terminal 2.

The information of the result of processing is displayed on a not shown screen, and the screen is returned to the personal button menu screen PIC18 by manipulating a confirmation button in the above screen. However, in the returned personal button menu screen PIC18, the display region R50 is changed to clarify a present state of registration.

The personal button menu screen PIC18 can be returned to the data input screen PIC14 by manipulating a “return” icon I73.

The same effect as that of the first embodiment can be also acquired by the third embodiment. Further, according to the third embodiment, since the function of the processing for specifying the work contents is more enhanced, a possibility that an employee executes a work content specifying operation, without being loath to execute it, can be greatly increased. Accordingly, it can be expected that an employee properly executes an input operation when work contents are changed and that the accuracy of a resultant record value can be more increased.

(D) Other Embodiments

While various modifications have been also described in the explanation of the above embodiment, modifications can be further exemplified as described below.

Although the example that a worker is authenticated making use of a fingerprint is shown in the first to third embodiments, other biometric data (for example, palm pattern data, iris data, handwriting data, and the like) may be utilized. Further, information, which is obtained at other timing such as when a personal computer is logged in, may be used as the information which is used together with biometric data for authentication.

Further, the first to third embodiments show that a fingerprint is identified only at the timing at which log-in is executed, it may be also identified at other timing. For example, an input operation executed by reading a fingerprint may be handled as if the “registration of business operation start time” icon I3 is manipulated by omitting the icon I3 and displaying a message that “place a finger on a fingerprint reader at the start of business operation”. Further, when the record value of an employee or a subordinate is edited, an operator, who executes an edit operation, may be reconfirmed by identifying his or her fingerprint. The above function is born by the worker authentication use input subsection P13 of FIG. 2.

In the first to third embodiments, the information during work of an employee can be displayed on the reduced window screen at all the times. However, the information during work of a subordinate and a managed employee may be displayed on, for example, a reduced list-display window screen of the employee's terminals of a management-level employee and a system manager (employee) at all times, and this display mode may be turned on and off by the management-level employee and the system manager. Further, a part of the subordinates may be selected and the information during work of the selected subordinates may be displayed. In this case, a hierarchical relation can be grasped from an authority flag, a department name, and the like, the work record acquisition system takes out the information during work of pertinent subordinates and managed employees, summarizes the information in a table format, and supplies it to the worker's terminals of management-level employees and system managers.

With the above operation, the management-level employees can easily grasp the present working state of the subordinates, thereby it can be expected that a subordinate managing ability can be improved. Further, the system managers can also grasp the reliability and the like of the start time input operation executed by the managed employees, based on which the system managers can give the managed employees guidance as to the input operation.

The first to third embodiments show the case that the employees are classified to two ranks (three ranks when the system managers are taken into consideration). However, the employees may be grouped to more than three ranks, and an authority flag may be given to the employees of each rank, and the contents for editing the record value of the subordinates may be changed depending of the level of a boss. Some of the bosses may change and delete the work record of the subordinates in addition to that they insert the work record.

Further, the first to third embodiments show the case that the time at which the “registration of business operation start time” icon I3 is manipulated is set as a time at which a new work starts as well as a time at which a previous work is finished. However, an offset time may be provided such that a new work start time is set to the time at which X minutes (for example, two minutes) passes from the time at which the “registration of business operation start time” icon I3 is manipulated and a previous work finish time is set to the time Y minutes (for example, two minutes) earlier than the time at which the “business operation start time registration” icon I3 is manipulated. A similar offset time may be provided with the “business operation finished” icon.

Although the first to third embodiments show the case that the time at which the “business operation start time registration” icon I3 is manipulated is set as the new work start time, the new work start time may be input to the terminal 2 by other operation. For example, an ID tag may be provided with the worker's terminal 2, and a time, at which an ID tag is read immediately after work contents are specified, may be set as the new work start time.

Although the first to third embodiments show the case that the step up to the acquisition of the work record is executed, these embodiments may be provided with a work record aggregating section for aggregating the work record or may be associated with an external aggregating section. Further, a log-in time and a log-out time may be supplied to an external system as a clock-in time and a clock-out time. Further, data other than working hour data may be aggregated. For example, the turn-on and turn-off times (including the times turned on and off by a screen saver) of the display of a personal computer as the worker's terminal 2 may be aggregated as the information for confirming working hours. Likewise, information as to post-edit such as the number of times of inputs executed for edit may be aggregated. The differences between methods of inputs such as an ordinary input executed by an employee, a post-input executed by an employee, and an input for change executed by a boss may be aggregated.

Although the first embodiment explains the case that when a process scheduled on the day is input, it is stored in association with a data input screen, a process that is input (work contents) may be stored as a file. For example, a personal work content file as shown in FIG. 31 may be provided which shows an employee number, a work number (or a plurality of work numbers), and the work contents represented by the work number in the same sequence of display as that of the input display field F15 (refer to FIG. 12). With the above arrangement, a business operation start time can be also indicated by selecting a process (work contents), input in the past, at a future date. That is, when the work number of an employee is described in the personal work content file, the work number and work contents are displayed in the input display field F15 even in a data input screen immediately after log-in (for example, refer to PIC2 of FIG. 10).

Further, a post-input method, which stores the start time of a work executed outside in a mobile type simple information processing device and transmits it to the worker's terminal 2, may be admitted.

Although the third embodiment shows the case that after the project information, which is registered by an employee, is arranged so as to be used by the system by processing it by the project management section at every predetermined cycle, other employees can use the project, other case can be admitted that the project may be notified to the employees (of the same department) by e-mail and the like.

Although the third embodiment shows the case that the one-touch specifying button is provided for the combinations of projects and processes, a one-touch specifying button for each project and/or each process may be also provided.

Note that a final time may be set to make the manipulation of the “today's business operation finished” icon I7 valid. The final time may be set independent of a log-in time or may be set to a time that passes a predetermined period of time after the log-in time. Further, a time interval handled as a day may not be limited to 24 hours and may be variably set. For example, a time interval from AM 0.01 to AM 2:00 on the next day may be regarded as the same day in aggregation.

1. A work record acquisition system in which respective worker's terminals are connected to a work record acquisition server common to a plurality of workers through a network, wherein the work record acquisition server comprises:
work record storage means for storing the work record of each of the workers;
input screen display control means for displaying a data input screen, on which at least a type of work, a work start time, and a finish of business operation can be designated, on each of the worker's terminals;
work record calculation/storage means for writing, when a type of work and a work start time are designated from any one of the worker's terminals, a new work record including at least the received type of work and the received work start time in the storage region of the worker relating to the worker's terminal of the work record storage means, and writing the working hours, which are determined by the start time of an immediately previous work and the start time of the received new work, in the working hour column of the work record of the immediately previous work; and
final work record calculation/storage means for writing, when a finish of business operation is designated from any one of the worker's terminals, the working hours, which are determined by the start time of a final work and the time at which the finish of business operation is received, in the working hour column in the final work record of the worker relating to the worker's terminal of the work record storage means.

2. A work record acquisition server connected to respective worker's terminals through a network, comprising: work record storage means for storing the work record of each of the workers;
input screen display control means for displaying a data input screen, on which at least a type of work, a work start time, and a finish of business operation can be designated, on each of the worker's terminals;
work record calculation/storage means for writing, when a type of work and a work start time are designated from any one of the worker's terminals, a new work record including at least the received type of work and the received work start time in the storage region of the worker relating to the worker's terminal of the work record storage means, and for writing the working hours, which are determined by the start time of an immediately previous work and the start time of the received new work, in the working hour column of the work record of the immediately previous work; and
final work record calculation/storage means for writing, when a finish of business operation is designated from any one of the worker's terminals, the working hours, which are determined by the start time of a final work and the time at which the finish of business operation is received, in the working hour column in the final work record of the worker relating to the worker's terminal of the work record storage means.

3. A work record acquisition server according to claim 2 further comprising:
biometric data storage means for storing the biometric data of the respective workers; and
worker authentication means for permitting the input screen display control means to display the data input screen on any one of the worker's terminals, making it at least one condition for the permission that the biometric data supplied from the any one of the worker's terminals is stored in the biometric data storage means.

4. A work record acquisition server according to claim 3, wherein the work record calculation/storage means captures the time at which the biometric data stored in the biometric data storage means is supplied from the worker's terminal during the data input screen is displayed as the designation of a work start time.

5. A work record acquisition server according to claim 2, further comprising screen during work display control means for causing the predetermined worker's terminal to continuously display a screen during work which includes the information during work created from the information relating to the final work of a worker in the work record storage means and the screen during work is smaller than the display screen of the worker's terminal.

6. A work record acquisition server according to claim 5, wherein the screen during work display control means causes the worker's terminal of a worker, relating to information during work, to display the screen during work.

7. A work record acquisition server according to claim 5, comprising authority storage means for storing an authority level in the relationship between the respective workers, wherein the screen during work display control means causes the worker's terminal of a worker having a higher authority level to display the screen during work including the information during work of a worker or a plurality of worker whose authority level relating to the above worker is low.

8. A work record acquisition program mounted on a work record acquisition server connected to respective worker's terminals through a network, comprising:
a work record storage section for storing the work record of each of the workers;
an input screen display control functional section for displaying a data input screen, on which at least a type of work, a work start time, and a finish of business operation can be designated, on each of the worker's terminals;
a work record calculation/storage functional section for writing, when a type of work and a work start time are designated from any one of the worker's terminals, a new work record including at least the received type of work and the received work start time in the storage region of the worker relating to the worker's terminal of the work record storage section, and for writing the working hours, which are determined by the start time of an immediately previous work and the start time of the received new work, in the working hour column of the work record of the immediately previous work; and
a final work record calculation/storage functional section for writing, when a finish of business operation is designated from any one of the worker's terminals, the working hours, which are determined by the start time of a final work and the time at which the finish of business operation is received, in the working hour column in the final work record of the worker relating to the worker's terminal of the work record storage section.

9. A work record acquisition program according to claim 8 further comprising:
a biometric data storage section for storing the biometric data of the respective workers; and
a worker authentication functional section for permitting the input screen display control functional section to display the data input screen on any one of the worker's terminals making it at least one condition for the permission that the biometric data supplied from the any one of the worker's terminals is stored in the biometric data storage section.

10. A work record acquisition program according to claim 9, wherein the work record calculation/storage functional section captures the time at which the biometric data stored in the biometric data storage section is supplied from the worker's terminal, during the data input screen is displayed, as the designation of a work start time.

11. A work record acquisition program according to claim 8, further comprising a screen during work display control functional section for causing the predetermined worker's terminal to continuously display a screen during work which includes the information during work created from the information relating to the final work of a worker in the work record storage section, and the screen during work is smaller than the display screen of the worker's terminal.

12. A work record acquisition program according to claim 11, wherein the screen during work display control functional section causes the worker's terminal of a worker, relating to information during work, to display the screen during work.

13. A work record acquisition program according to claim 11, comprising an authority storage section for storing an authority level in the relationship between the respective workers, wherein the screen during work display control functional section causes the worker's terminal of a worker having a higher authority level to display the screen during work including the information during work of a worker or a plurality of worker whose authority level relating to the above worker is low.
input screen display control means for displaying a data input screen, on which at least a type of work, a work start time, and a finish of business operation can be designated, on each of the worker's terminals;
work record calculation/storage means for writing, when a type of work and a work start time are designated from any one of the worker's terminals, a new work record including at least the received type of work and the received work start time in the storage region of the worker relating to the worker's terminal of the work record storage means, and writing the working hours, which are determined by the start time of an immediately previous work and the start time of the received new work, in the working hour column of the work record of the immediately previous work; and
final work record calculation/storage means for writing, when a finish of business operation is designated from any one of the worker's terminals, the working hours, which are determined by the start time of a final work and the time at which the finish of business operation is received, in the working hour column in the final work record of the worker relating to the worker's terminal of the work record storage means.

14. A work record acquisition server according to claim 6, comprising authority storage means for storing an authority level in the relationship between the respective workers, wherein the screen during work display control means causes the worker's terminal of a worker having a higher authority level to display the screen during work including the information during work of a worker or a plurality of worker whose authority level relating to the above worker is low.
